(19) United States
(12) Patent Application Publication
(10) Pub. No.: US 2023/0073382 A1
(43) Pub. Date: Mar. 9, 2023

(54) ESTIMATION DEVICE, VIBRATION SENSOR SYSTEM, METHOD EXECUTED BY ESTIMATION DEVICE, AND PROGRAM

(71) Applicants: TOKYO SOKUSHIN CO., LTD., Tokyo (JP); KURAHASHI RUBBER INDUSTRY CO., LTD., Tokyo (JP)

(72) Inventors: Shigeo KINOSHITA, Tsukuba-shi, Ibaraki (JP); Shinsuke SATO, Adachi-ku,Tokyo (JP)

(73) Assignees: TOKYO SOKUSHIN CO., LTD., Tokyo (JP); KURAHASHI RUBBER INDUSTRY CO., LTD., Tokyo (JP)

(21) Appl. No.: 17/904,673

(22) PCT Filed: Feb. 17, 2021
(86) PCT No.: PCT/JP2021/005883

§ 371 Date: Aug. 19, 2022

(30) Foreign Application Priority Data
Feb. 21, 2020 (JP) 2020-028155

(51) Int. Cl. G01V 1/36; G01H 1/00; G01H 17/00

(52) U.S. Cl. CPC G01V 1/364; G01H 1/00; G01H 17/00

(57) ABSTRACT

An object of the present invention is to provide a method of a practical level for performing sensor fusion of multiple vibration sensors such as a seismometer, and in an example, to extend a dynamic range of a high-sensitivity geophone by sensor fusion of the high-sensitivity geophone and a low-sensitivity acceleration geophone. A state related to the high-sensitivity geophone is estimated by capturing, in a Kalman filter, an acceleration record from the low-sensitivity acceleration geophone and a velocity record, or a displacement record, and an acceleration record of the high-sensitivity geophone, and estimating and calculating them as the linear Kalman filter problem with a control input. The high-sensitivity geophone is an actual device, but the state can be estimated using a sensor value of the low-sensitivity acceleration geophone even when the record is saturated. This extends the dynamic range of the high-sensitivity geophone.

### TECHNICAL FIELD

The present invention relates to an estimation device that estimates a state related to a vibration sensor such as a seismometer, a vibration sensor system using the same, and a method and program relating thereto. The present invention particularly relates to an estimation device that estimates a state related to a vibration sensor by sensor fusion for integrating data from multiple sensors (also referred to as measuring devices), a vibration sensor system, and a method and program relating thereto.

### BACKGROUND ART

The sensor fusion is a technique by which data from multiple sensors is joined together to take their advantages, compensate the drawbacks and estimate and control a state of an object. An integrated inertial navigation system (chapter 9 of Non Patent Literature 1) in which position signals from a global navigation satellite system are integrated into an inertial navigation system with a gyroscope and an accelerometer is a typical successful example. In recent years, a sensor fusion technique for integrating various sensors including a millimeter wave radar for autonomous driving of an automobile in conjunction with an artificial intelligence (AI) technique has come to attract attention.

As techniques in the sensor fusion, statistical inference such as Bayesian inference and a maximum likelihood method is used (Non Patent Literature 2), but one of frequently used methods is Kalman filter (Non Patent Literature 3). Actually, Non Patent literature 1 covers an integrated inertial navigation system as one field of application of Kalman filter, in Kalman filter books. The statistical inference uses data from the sensors, and the sensor fusion has an object to determine how to integrate to utilize the data. The technique is an extroverted technique.

To observe earthquakes, a high-sensitivity short period velocimeter, a very broad band velocimeter, a strong motion seismometer, and the like have been used according to the purpose. In recent years, for example, there has been a worldwide trend in which the very broad band velocimeter and the strong motion seismometer are both provided and the earthquakes are detected in real time with a wider dynamic range. This integration is an introverted technique to improve the performance of the sensor itself, and is free of magnificence of a global navigation satellite system and autonomous driving of an automobile. However, the sensor fusion in which multiple seismometers are fused and integrated is one of important technical objects in the earthquake observation seeking extension of measurement frequency band and dynamic range. The basis of the sensor fusion in the earthquake observation is the integration of two types of seismometers. For example, the sensor fusion of the very broad band velocimeter and the short period velocimeter is used to extend the measurement frequency band. This can be easily implemented by complementary filtering (Non Patent Literature 4). However, as far as the inventors know, the current situation is considered in which the sensor fusion of a kind for extending the dynamic range by fusing two types of seismometers has not reached a practical level yet.

### CITATION LIST

### Non Patent Literature

Non Patent Literature 1: Grewal, M. S. and A. P. Andrews (2008). Kalman filtering, Wiley-IEEE Press.

Non Patent Literature 2: Kagami Shingo, Ishikawa Masatoshi (2005), Sensor Fusion-An Architectural Perspective on Information Processing in Sensor Networks-The IEICE Transactions on Fundamentals of Electronics, Communications and Computer Sciences (Japanese edition) A, J88-A, No. 12, 1404-1412

Non Patent Literature 3: Kalman, R. E. (1960). A new approach to linear filtering and prediction problems, ASME. Journal of Basic Engineering, 82, 34-45

Non Patent Literature 4: Kinoshita Shigeo (2014), State Feedback Sensor and Response Compensation using Complementary Filtering, Earthquake, 66, 101-113

Non Patent Literature 5: Anderson, B. D. O. and J. B. Moore (1979). Optimal filtering, Prentice-Hall, Inc.

### SUMMARY OF INVENTION

### Technical Problem

In view of the foregoing, an object of the present invention is to provide a method of a practical level for performing sensor fusion of multiple vibration sensors such as a seismometer.

### Solution to Problem

In order to solve the above-mentioned problem, the present invention provides an estimation device that estimates, according to discrete time, a state vector related to a vibration sensor and calculates a covariance matrix related to the state vector according to the discrete time, the state vector changing in time according to an external input, the estimation device comprising: a measurement acquisition unit that acquires a measurement measured by an external measurement device of a physical quantity related to vibration as the external input; a sensor value acquisition unit that acquires a sensor value of the vibration sensor; a data storage unit that stores a state vector estimate obtained by previous estimation, a post covariance matrix obtained by previous calculation, the measurement corresponding to a time corresponding to the previous estimation and the previous calculation, and a covariance matrix of a system noise; a state vector prior estimate calculation unit that calculates a state vector prior estimate using the state vector estimate obtained by the previous estimation and the measurement corresponding to the time corresponding to the previous estimation and the previous calculation; a prior covariance matrix calculation unit that calculates a prior covariance matrix using the post covariance matrix obtained by the previous calculation and the covariance matrix of the system noise; a Kalman gain calculation unit that calculates a Kalman gain using the prior covariance matrix; a state vector estimate calculation unit that calculates a state vector estimate in present estimation using the state vector prior estimate, the Kalman gain, and the sensor value; and a post covariance matrix calculation unit that calculates a post covariance matrix in present calculation using the prior covariance matrix and the Kalman gain.

The present invention provides a vibration sensor system comprising: the vibration sensor; the external measurement device; and the above-described estimation device.

The external measurement device may be capable of converting acceleration by calculation, and have a dynamic range exceeding an upper limit of a dynamic range of the vibration sensor, and the measurement acquisition unit may acquire a measurement of the acceleration.

The vibration sensor may comprise a pendulum, and the vibration sensor may measure values of one or more of displacement, velocity, and acceleration, and the sensor value acquisition unit may acquire the values of one or more of the displacement, the velocity, and the acceleration.

The Kalman gain calculation unit may adjust a Kalman gain by calculation using a Kalman gain adjustment term, and when the values of one or more of the displacement, the velocity, and the acceleration of the vibration sensor are greater than predetermined values, the Kalman gain may be adjusted to increase the Kalman gain adjustment term as compared with a case where the one or more values are smaller than the predetermined values, so that the Kalman gain is reduced.

The vibration sensor may be a vibration sensor that comprises a pendulum and measure values of one or more of displacement, velocity, and acceleration, and may be provided, by a subsequent-stage Kalman filter, with a simulated sensor that simulates an operation of a vibration sensor comprising a pendulum by calculation, and determine values of one or more of displacement, velocity, and acceleration of a simulated pendulum by calculation, and the state vector estimate calculation unit may use, as the sensor value, the values of one or more of the displacement, the velocity, and the acceleration measured by the vibration sensor or values obtained by multiplying a coefficient by the values of one or more of the displacement, the velocity, and the acceleration of the simulated pendulum determined by the simulated sensor, according to magnitudes of the values of one or more of the displacement, the velocity, and the acceleration measured by the vibration sensor.

The present invention provides a method, to be executed by an estimation device, of estimating, according to discrete time, a state vector related to a vibration sensor and calculating a covariance matrix related to the state vector according to the discrete time, the state vector changing in time according to an external input, the method comprising the steps of; acquiring a measurement measured by an external measurement device of a physical quantity related to vibration as the external input; acquiring a sensor value of the vibration sensor; calculating a state vector prior estimate using a state vector estimate obtained by previous estimation and a measurement corresponding to a time corresponding to the previous estimation and previous calculation; calculating a prior covariance matrix using a post covariance matrix obtained by the previous calculation and a covariance matrix of a system noise; calculating a Kalman gain using the prior covariance matrix; calculating a state vector estimate in present estimation using the state vector prior estimate, the Kalman gain, and the sensor value; and calculating a post covariance matrix in present calculation using the prior covariance matrix and the Kalman gain.

The present invention provides a program that causes a computer to execute a method of estimating, according to discrete time, a state vector related to a vibration sensor and calculating a covariance matrix related to the state vector according to the discrete time, the state vector changing in time according to an external input, the program causing the computer to execute the steps of; acquiring a measurement measured by an external measurement device of a physical quantity related to vibration as the external input; acquiring a sensor value of the vibration sensor; calculating a state vector prior estimate using a state vector estimate obtained by previous estimation and a measurement corresponding to a time corresponding to the previous estimation and previous calculation; calculating a prior covariance matrix using a post covariance matrix obtained by the previous calculation and a covariance matrix of a system noise; calculating a Kalman gain using the prior covariance matrix; calculating a state vector estimate in present estimation using the state vector prior estimate, the Kalman gain, and the sensor value; and calculating a post covariance matrix in present calculation using the prior covariance matrix and the Kalman gain.

### Advantageous Effect of Invention

According to the present invention, the sensor fusion of multiple vibration sensors makes it possible to integrate and use the multiple vibration sensors such as a seismometer. In an example, the sensor fusion of the high-sensitivity geophone and the low-sensitivity geophone makes it possible to extend a dynamic range of the high-sensitivity geophone.

### BRIEF DESCRIPTION OF DRAWINGS

FIG. 1 is a diagram conceptually illustrating a flow of sensor fusion.

FIG. 2 is a block diagram illustrating a configuration of sensor fusion using a Kalman filter.

FIG. 3 is a block diagram illustrating a configuration of a vibration sensor system according to an embodiment of the present invention.

FIG. 4 is a block diagram illustrating a device configuration example of an estimation device.

FIG. 5 is a diagram illustrating an example of a vibration sensor (a high-sensitivity velocimeter).

FIG. 6 is a block diagram illustrating a configuration of a simulated vibration sensor.

FIG. 7 is a block diagram illustrating continuous-time system state space representation of the high sensitivity velocimeter (an FSF sensor).

FIG. 8 is a diagram illustrating a relationship between a state vector of restoring acceleration of the FSF sensor and a feedback gain.

FIG. 9 is a graph showing frequency response characteristics (a model lag) equivalent to the VBB with respect to an acceleration input of the FSF sensor.

FIG. 10 is a configuration diagram of an example of a velocimeter (quoted from the manufacturer's instruction manual for “VSE-15D-6” made by TOKYO SOKUSHIN Co., LTD.).

FIG. 11 is a flowchart illustrating an operational flow during design of a vibration sensor system.

FIG. 12 is a flowchart illustrating an operational flow during operation of the vibration sensor system.

FIG. 13 is a flowchart illustrating an operational flow of a processing portion using a Kalman filter in the operational flows in FIGS. 11 and 12.

FIG. 14 is a diagram illustrating an example of a vibration sensor (a high-sensitivity displacement sensor).

FIG. 15 is a block diagram illustrating a configuration of sensor fusion of the high-sensitivity displacement sensor and a strong motion seismometer using the Kalman filter.

FIG. 16 is a block diagram illustrating continuous-time system state space representation of the high sensitivity displacement sensor.

FIG. 17 is a diagram illustrating a high-sensitivity negative feedback accelerometer (a force balance accelerometer) as an example of a vibration sensor (a high-sensitivity accelerometer).

FIG. 18 is a block diagram illustrating a configuration of sensor fusion of the high-sensitivity accelerometer and the strong motion seismometer using a Kalman filter.

FIG. 19 is a block diagram illustrating continuous-time system state space representation of the high sensitivity accelerometer.

### DESCRIPTION OF EMBODIMENTS

Hereinafter, embodiments for carrying out the present invention will be described. It should be noted that the present invention is not limited to the specific embodiments described below and can be appropriately changed within the scope of the claims of the present invention.

In the following embodiments, there is proposed one method of extending a dynamic range of a high-sensitivity geophone (a high-sensitivity vibration sensor) by performing sensor fusion of the high-sensitivity geophone and a low-sensitivity acceleration geophone (a low-sensitivity vibration sensor as an example of an “external measurement device”) having a dynamic range exceeding a dynamic range of the high-sensitivity geophone. The sensor fusion of a very broad band (VBB) velocimeter and a strong motion seismometer is first developed as a specific example, but the method is applicable to the integration of three types of high-sensitivity seismometers (a displacement sensor, a velocimeter, and an accelerometer) and the strong motion seismometer.

Concept of Sensor Fusion

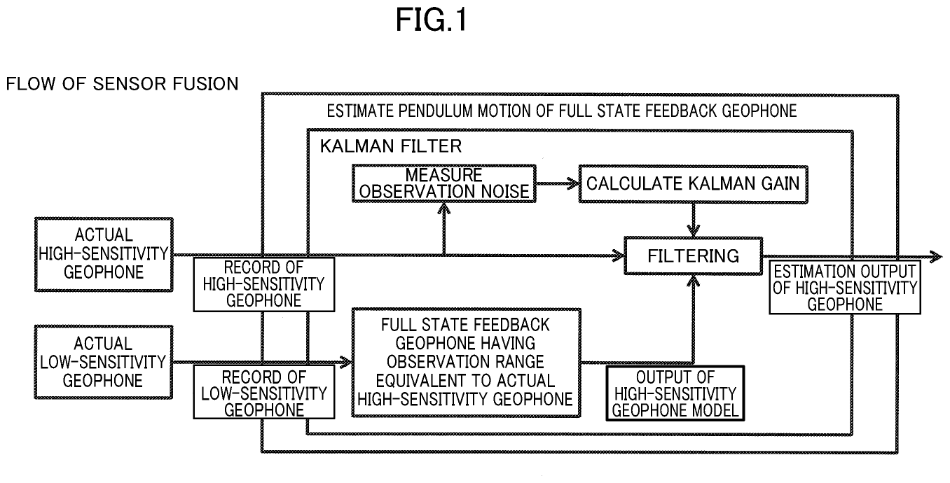

An example of a flow of sensor fusion to be proposed is conceptually illustrated in FIG. 1. In this example, an acceleration record observed by a strong motion seismometer and a record observed by a high-sensitivity geophone in parallel to the observation by the strong motion seismometer are fused to extend a dynamic range. Therefore, a virtual sensor (simulated sensor) equivalent to the high-sensitivity geophone can be constructing using software (as described later, the sensor fusion may be performed using not the virtual sensor but an actual high-sensitivity geophone or by combining the virtual sensor and the actual sensor as necessary). The virtual sensor is referred to as a full-state-feedback (abbreviation: FSF) sensor (Non Patent Literature 4). The FSF sensor is equivalent to the high-sensitivity geophone, and therefore the high-sensitivity geophone is expressed in a state space, which makes it possible to apply, as a determined signal, the observed acceleration to an input, and apply the determined signal to an output with a normality noise added to the record observed by the high-sensitivity geophone. Here, the “state” is a state of pendulum motion in the FSF sensor. Accordingly, the output of the high-sensitivity geophone, i.e., the output of the FSF sensor is estimated from the state of a pendulum obtained using a Kalman filter. Since the FSF sensor as a virtual sensor is not an actual device, the FSF sensor can escape from the restriction of a power supply voltage. Therefore, if the accelerometer operates normally even when the record actually observed by the high-sensitivity geophone is clipped (even when the record exceeds a predetermined value and is saturated), the estimated output of the FSF sensor is performed in a state where the record is not clipped, by increasing an observation noise to be added to the actual record of the high-sensitivity geophone to reduce a Kalman gain. Reducing the observation noise to increase the Kalman gain enables an actually observed waveform to be faithfully output from the Kalman filter. Hereinafter, the term “high-sensitivity geophone” refers to a high-sensitivity geophone as an actual device.

Configuration of Sensor Fusion Using Virtual Sensor (Software Sensor)

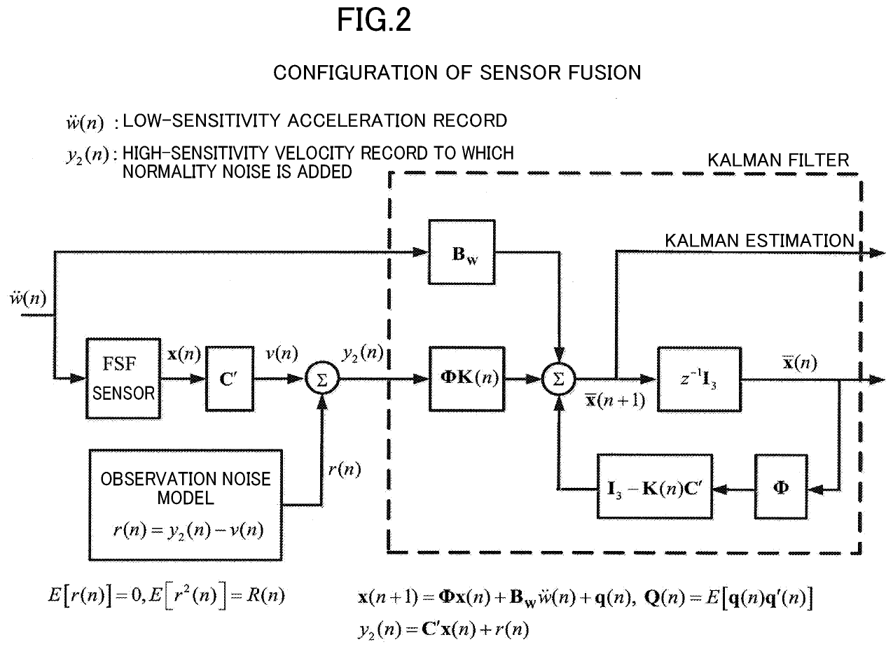

FIG. 2 is a block diagram illustrating a configuration of sensor fusion using a Kalman filter. For the sake of simplifying the description, here, the FSF sensor is a simulated velocimeter, but the FSF sensor may be a simulated displacement sensor or an accelerometer as described later, and alternatively, the FSF sensor operates as both of the simulated displacement sensor and the velocimeter to fuse a low-sensitivity geophone (an accelerometer) and both of the displacement sensor and the velocimeter, whereby the sensor fusion can be performed using a number of vibration sensors.

In the block diagram of FIG. 2,

\ddot{w}(n) [Expression 1]

represents an acceleration record of the low-sensitivity accelerometer (the unit is meters per second squared (m/s²), and the same applies to the following), and yₘ(n) represents a record of a high-sensitivity seismometer to which the normality noise is added. Specifically, in the example of FIG. 2, when m is 2, yₘ(n) is a velocity record of the high-sensitivity velocimeter (the unit is meters per second (m/s), and the same applies to the following), and when m is 3, yₘ(n) is an acceleration record of the high-sensitivity accelerometer (the unit is meters per second squared (m/s²), and the same applies to the following), and when m is 1, y₁(n) is a displacement record of the high-sensitivity displacement sensor (the unit is meters (m), and the same applies to the following). Here, n is an integer and represents a discrete time. When a sampling time is expressed by Δt, an actual time corresponding to the discrete time n is expressed by nΔt (the unit is s, and the same applies to the following), and should be originally expressed by nΔt, but Δt is omitted for simplification. In FIG. 2, Σ indicates that signal values toward the Σ are added and the resulting value is output in an output direction (the same applies to the following, and when a minus sign is applied to a signal value, the signal value is not added but is subtracted). z is a time transition operator that causes the discrete time to transition from n to n+1, and z⁻¹ is an operator for performing the inverse operation (that causes the discrete time to transition from n+1 to n).

C′ [Expression 2]

represents an operator for converting the state vector into observation data (which is expressed by a matrix or a vector corresponding to an object to be observed), and assuming that a state at the discrete time n (a state vector) is expressed by

X(n) [Expression 3]

(a column vector), and an estimate of the state vector at the discrete time n by the Kalman filter is expressed by

\hat{x}(n) [Expression 4]

, an estimate of an observation quantity is obtained by the following observation equation:

ŷ(n)=C′\hat{x}(n) [Expression 5]

(Equation 1)

I₃ [Expression 6]

represents a three-dimensional unit matrix.

Φ [Expression 7]

represents a transition matrix that defines the transition of the state vector, and

B_{w} [Expression 8]

represents a column vector that selects an input signal, and the values of Φ and B_{w} are specifically defined according to the model.

K(n) [Expression 9]

represents a Kalman gain, and in this example, is determined, as a vector (a column vector) in a filtering step as described later.

As illustrated in FIG. 2, the record yₘ(n) obtained by adding an observation noise r(n) to the acceleration record of the low-sensitivity accelerometer

\ddot{w}(n) [Expression 10]

and the record of the high-sensitivity velocimeter

v(n) [Expression 11]

is input to the Kalman filter. The observation noise r(n) represents the normality noise, wherein the average value E[r(n)] is zero, and the variance E[r²(n)] is expressed by R(n) (E represents a statistical average, and the same applies to the following). R(n) is a quantity set from outside (by a user or the like of the vibration sensor system), and therefore the magnitude of the Kalman gain can be adjusted by adjusting R(n).

In the sensor fusion illustrated in FIG. 2,

\ddot{w}(n) [Expression 12]

is regarded as a control input from the outside, yₘ(n) is regarded as an observation value, and using these values, the state related to the FSF sensor is estimated by executing a prediction step and a filtering step of a linear Kalman filter. yₘ(n) obtained by adding the normality noise to the observation value actually observed by the high-sensitivity geophone is input as yₘ(n) in FIG. 2 (in FIG. 2, m is 2, but m is any numerical value as described above), and is estimated by the Kalman filter. The state estimation by the Kalman filter in FIG. 2 is performed with respect to a linear system described by

x(n+1)=Φx(n)+B_{w}\ddot{w}(n)+q(n) [Expression 13]

(Equation 2)

and

yₘ(n)=C′x(n)+r(n) [Expression 14]

(Equation 3)

### Here,

Q(n)=E[q(n)q′(n)] [Expression 15]

(Equation 4)

R(n)=E[r²(n)] [Expression 16]

(Equation 5)

Note that

q(n) [Expression 17]

represents a normality system noise (the average is a zero column vector), and

q′(n) [Expression 18]

represents a row vector given as a transposed matrix of

q(n) [Expression 19]

, In this specification, [*]′ represents a transposed matrix of a matrix (or a vector) [*] or a vector given as the transposed matrix. A symbol ′″ represents transposition. In addition,

Q(n) [Expression 20]

expressed by (Equation 4) represents a covariance matrix of the system noise.

Specific Configuration of Vibration Sensor System

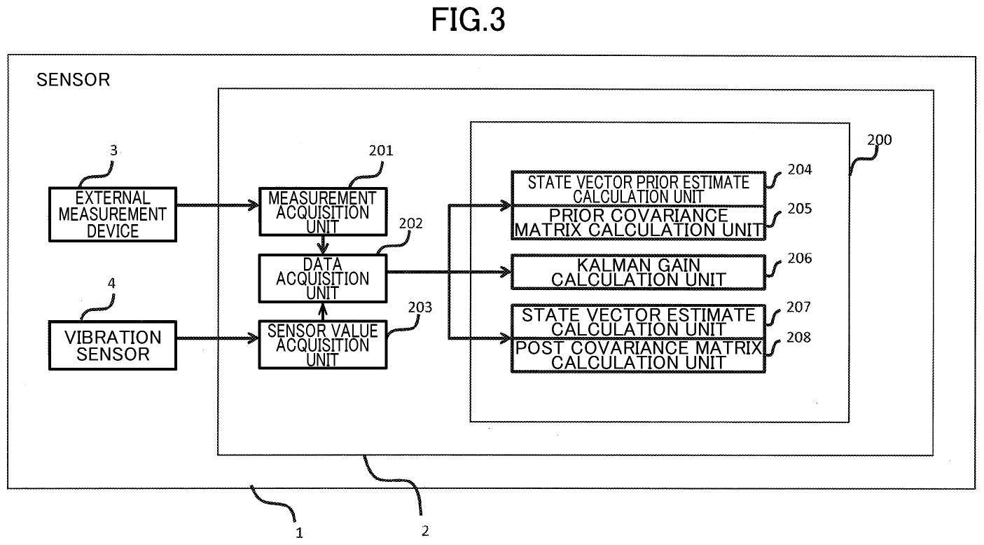

Next, a specific configuration of the vibration sensor system for performing the sensor fusion according to the present invention will be described. FIG. 3 is a block diagram illustrating the configuration of the vibration sensor system according to an embodiment of the present invention. A vibration sensor system 1 includes an estimation device 2, an external measurement device 3, and a vibration sensor 4, and the estimation device 2 includes a Kalman filter calculation unit 200 having parameters of a simulated sensor.

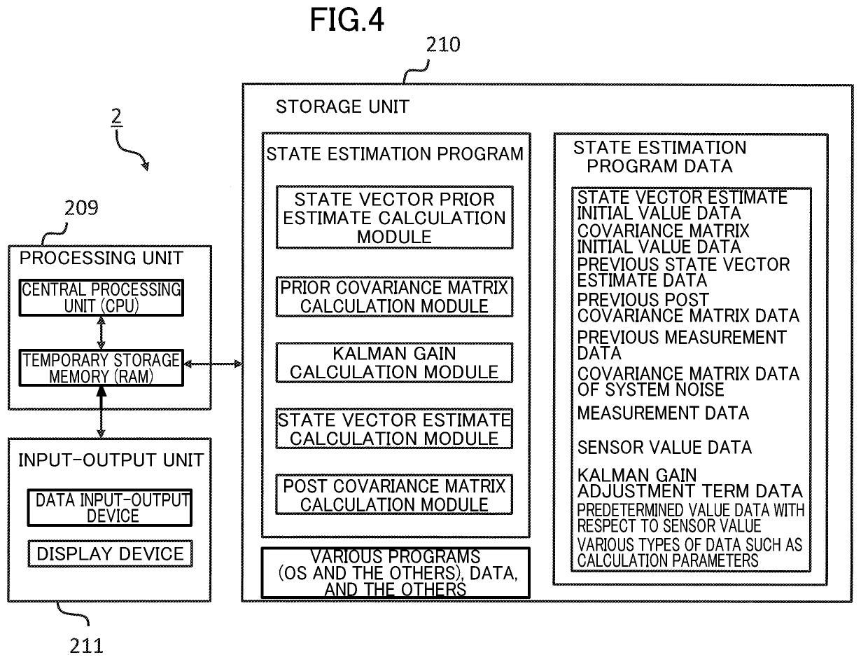

The estimation device 2 is a device for performing estimation by the above-described Kalman filter, and includes a measurement acquisition unit 201, a data storage unit 202, and a sensor value acquisition unit 203. The Kalman filter calculation unit 200 is a device for operating the Kalman filter using the simulated sensor equivalent to the vibration sensor in the measurement band, and includes a state vector prior estimate calculation unit 204, a prior covariance matrix calculation unit 205, a Kalman gain calculation unit 206, a state vector estimate calculation unit 207, and a post covariance matrix calculation unit 208. These various functional units may be implemented by a computer for executing a state estimation program. A device configuration example of the estimation device as such an example is illustrated in a block diagram of FIG. 4. Whilst it is not essential to implement the estimation device 2 by the computer, the estimation device 2 may be configured using an integrated circuit such as an application specific integrated circuit (ASIC) or a field-programmable gate array (FPGA) or various functional units of the estimation device 2 may be configured by combining various calculation circuits and a storage circuit, for example.

The estimation device 2 illustrated in FIG. 4 includes a processing unit 209 including a central processing unit (CPU) and a temporary memory (a random access memory (RAM)), a storage unit 210 configured using a storage device such a hard disk drive and a solid state drive (SSD), and an input-output unit 211 including a data input-output device for inputting and outputting data according to the universal serial bus (USB) standard or the like, a display device, a keyboard, a mouse, and the like. The storage unit 210 stores therein a state estimation program, various programs such as an operating system (OS), state estimation program data, and the other various types of data, and the CPU executes the programs such as the state estimation program while appropriately reading the programs and data into the RAM, whereby the measurement acquisition unit 201, the data storage unit 202, the sensor value acquisition unit 203, the state vector prior estimate calculation unit 204, the prior covariance matrix calculation unit 205, the Kalman gain calculation unit 206, the state vector estimate calculation unit 207, and the post covariance matrix calculation unit 208 are implemented.

Specifically, the measurement acquisition unit 201 is a functional unit that acquires an acceleration value from the external measurement device 3 (accelerometer as the low-sensitivity geophone), and is first implemented by the data input-output device of the input-output unit 211 controlled by the CPU that executes the state estimation program and the various programs. The data storage unit 202 is implemented by the storage unit 210 controlled by the CPU that executes the state estimation program and the various programs, and stores, for estimation to be repeatedly performed, a state vector estimate obtained by the previous estimation, a post covariance matrix obtained by the previous calculation, measurements corresponding to the times corresponding to the previous estimation and the previous calculation, and the covariance matrix of the system noise, as described later. The sensor value acquisition unit 203 is a functional unit that acquires a sensor value of the vibration sensor 4, and is implemented by the data input-output device of the input-output unit 211 controlled by the CPU that executes the state estimation program and the various programs. The state vector prior estimate calculation unit 204 is a functional unit to be implemented by the CPU that executes the state estimation program (in particular, a state vector prior estimate calculation module) and the various programs, and calculates a state vector prior estimate. The prior covariance matrix calculation unit 205 is a functional unit to be implemented by the CPU that executes the state estimation program (in particular, a prior covariance matrix calculation module) and the various programs, and calculates a prior covariance matrix. The Kalman gain calculation unit 206 is a functional unit to be implemented by the CPU that executes the state estimation program (in particular, a Kalman gain calculation module) and the various programs, and calculates a Kalman gain. The state vector estimate calculation unit 207 is a functional unit to be implemented by the CPU that executes the state estimation program (in particular, a state vector estimate calculation module) and the various programs, and calculates a state vector estimate. The post covariance matrix calculation unit 208 is a functional unit to be implemented by the CPU that executes the state estimation program (in particular, a post covariance matrix calculation module) and the various programs, and calculates a post covariance matrix.

The external measurement device 3 is herein an accelerometer (which can convert the acceleration by the calculation, and has a dynamic range exceeding an upper limit of the dynamic range of the high-sensitivity geophone) as the low-sensitivity geophone, and is configured using a micro electro mechanical systems (MEMS)-type acceleration sensor, for example. The external measurement device 3 also includes an input-output device for inputting a command signal from the outside, outputting a measurement record of acceleration, and the like.

### First Embodiment

Model of High-Sensitivity Velocimeter

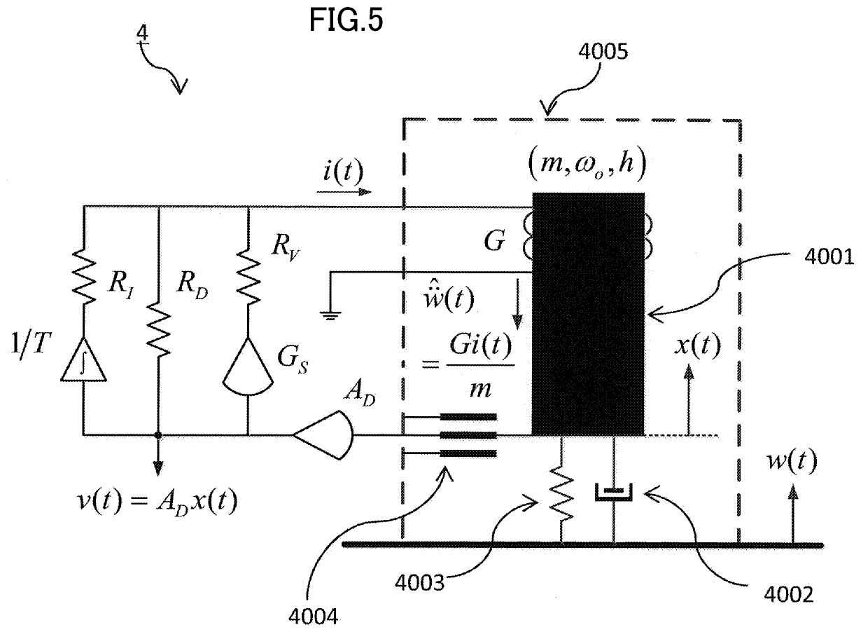

Next, an embodiment of a vibration sensor system using a model of a high-sensitivity velocimeter will be specifically described as a first embodiment of the present invention. FIG. 5 is a diagram illustrating an example of the vibration sensor 4 (a VBB seismometer as the high-sensitivity velocimeter).

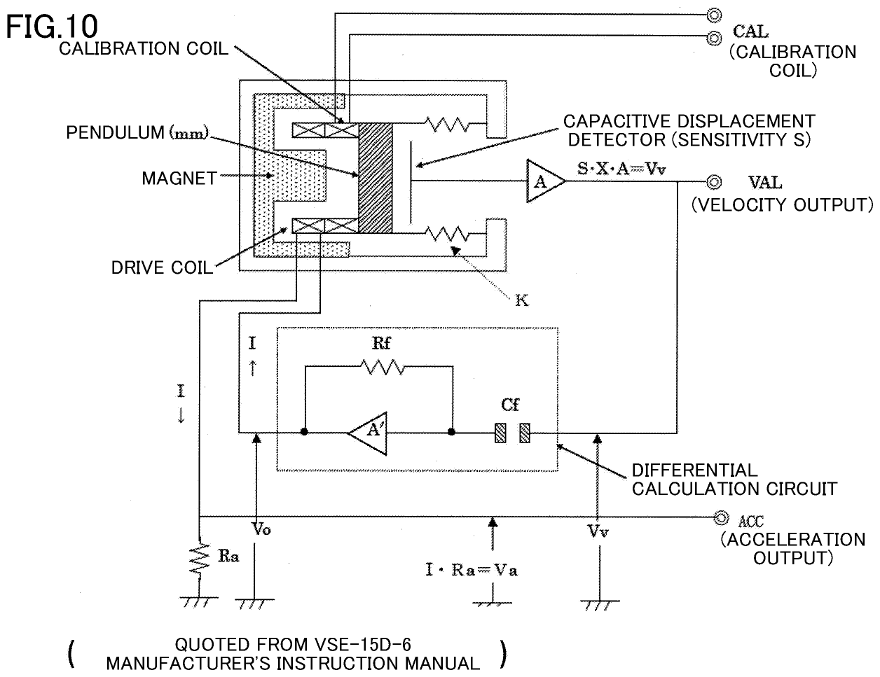

The FSF sensor is assembled in a manner similar to a negative feedback seismometer designed using classical proportional-integral-differential (PID) controller theory, and simulates the operation of the VBB seismometer illustrated in FIG. 5. The vibration sensor of FIG. 5 includes a pendulum 4001 (for specific connection between the pendulum and a servo coil, see FIG. 10, for example. Note that a calibration coil and a drive coil each are illustrated in a cross section in the plane of FIG. 10, and actually have an annular shape. A magnet is also illustrated in a cross section in the plane of FIG. 10, and actually has a cylindrical shape with a partially cut inner part), a damping element 4002 (which is a damper by air resistance but is without substance, as a specific example), a rigid element 4003 (a spring supporting the pendulum as a specific example), and a displacement detector 4004 including three capacitive plates (electrode plates), and these are housed in a container 4005. As illustrated in FIG. 5, the pendulum 4001 is connected to a central capacitive plate among the three capacitive plates included in the displacement detector 4004. The vibration sensor 4 includes a displacement-to-voltage conversion amplifier A_{D} (for the sake of convenience, a conversion coefficient of the amplifier A_{D} is expressed by A_{D} [V/m]), a differentiator G_{S} (for the sake of convenience, a coefficient of the differentiator G_{S} is expressed by G_{S}. The operation of the differentiator G_{S} is expressed by the following mathematical formula:

$$\begin{matrix}[ Expression 21 ] & \\ {G}_{S} \frac{d}{dt} ) , & \end{matrix}$$

an impedance element R_{I} (expressed by a resistor R[Ω]), an impedance element R_{D} (expressed by a resistor R_{D} [Ω]), and an impedance element R_{V} (expressed by a resistor R_{V} [Ω]), and includes an integrator expressed by an integral sign

∫ [Expression 22]

(T(s) is a time constant. The operation of the integrator is expressed by the following mathematical formula:

$$\begin{matrix}[ Expression 23 ] & \\ \frac{1}{T} \int ) . & \end{matrix}$$

Although not illustrated in FIG. 5, a magnet is arranged around the servo coil to which the pendulum 4001 is connected (see FIG. 10), and the servo coil moves in the magnetic field.

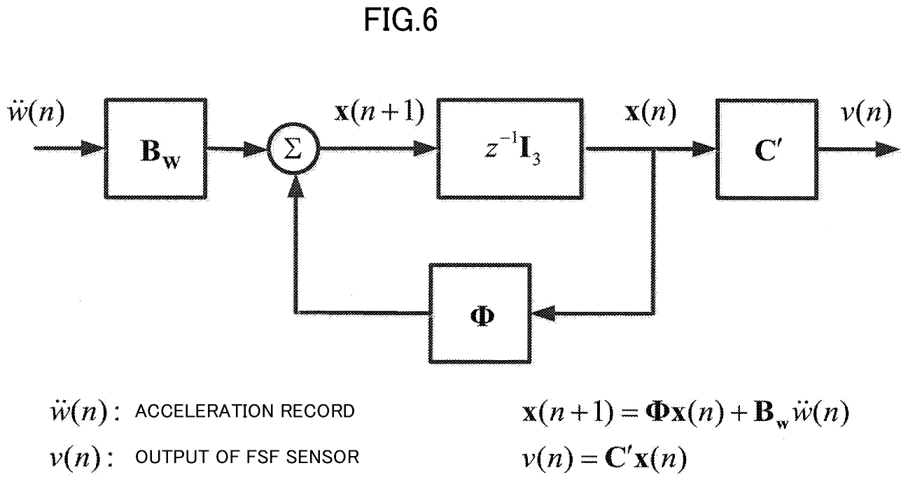

When input displacement w(t) (the unit is m. In this specification, if the unit is not specified, the quantity is expressed using the MKSA unit system) is applied to the vibration sensor 4 in response to a case where the ground surface or the like on which the vibration sensor 4 is installed vibrates, the pendulum 4001 vibrates (relative displacement of the pendulum in the storage container 4005 with respect to the container is expressed by x(t) (the unit is m)). Intervals among the three capacitive plates included in the displacement detector 4004 change in response to the displacement of the pendulum 4001. Specifically, assuming that each of the interval between the upper capacitive plate and the central capacitive plate and the interval between the central capacitive plate and the lower capacitive plate is d [m] in a stationary state, when the pendulum 4001 is displaced by x in a direction illustrated in FIG. 6, the central capacitive plate connected to the pendulum 4001 is also displaced in the same manner.

As a result, the interval between the upper capacitive plate and the central capacitive plate becomes d−x, and the interval between the central capacitive plate and the lower capacitive plate becomes d+x. Accordingly, each of the capacitance between the upper capacitive plate and the central capacitive plate and the capacitance between the central capacitive plate and the lower capacitive plate changes, and the displacement x of the pendulum 4001 is detected, as a voltage proportional to the displacement, by an electrical circuit A_{D}. The above-described circuit element performs the differential and integral calculus or the like with respect to the detected voltage, which causes a current i(t) to flow in the servo coil to control so that the pendulum 4001 rests. That is, the current i(t) flows (is fed back) in the servo coil in the magnetic field by the magnet (see FIG. 10) to thereby generate a force, and the generated force is used to control so that the pendulum rests. Specifically,

$$\begin{matrix}[ Expression 24 ] & \\ \hat{\ddot{w}} ( t ) = \frac{Gi ( t )}{m} & ( Equation 6 )\end{matrix}$$

is generated, as restoring acceleration, with respect to the input displacement w(t) (G [N/A] is a motor generator constant of the servo coil, and m [kg] is a mass of the pendulum 4001), and the restoring acceleration:

\ddot{ŵ}(t)=\ddot{w}(t) [Expression 25]

(Equation 7)

is achieved (“\ddot{ }” added above w means the second-order derivative with respect to time, and “\dot{ }” added above w means the first-order derivative with respect to time. Quantities other than w that change in time are indicated by the time derivative appropriately in the same manner.) The acceleration, velocity, and displacement are obtained, sensor values, from a current required for the control. Specifically, the acceleration output of the pendulum 4001 is obtained from an output terminal of the differentiator G_{S}, and the velocity output of the pendulum 4001 is obtained from an output terminal of the displacement-to-voltage conversion amplifier A_{D}, and the displacement output of the pendulum 4001 is obtained from an output terminal of the integrator.

Next, a model for simulating the operation of the VBB seismometer illustrated in FIG. 5 using the FSF sensor which is a virtual sensor will be described with reference to Non Patent Literature 4. First, as specifications, parameters of the pendulum system of the mechanism unit and the design target of the FSF sensor are provided as follows. [Pendulum System of Mechanism Unit]

Mass of pendulum=m [kg], Attenuation coefficient=h [dimensionless quantity], Natural circular frequency=ω₀ [rad], Motor generator constant of servo coil=G [N/A]

[Characteristics of FSF Sensor]Velocity output sensitivity Sv [V/(m/s)], Low band cut-off circular frequency=ω_{c}[rad], and

Attenuation coefficient =ζ (zeta)=0.6321 [Expression 26]

The FSF sensor is implemented in four steps on the basis of the above-described specifications. First, in step 1, a feedback gain vector (a column vector):

k=[k₁, k₂, k₃]′ [Expression 27]

(Equation 8)

is determined as follows. Here, a high band cut-off circular frequency ω₃ for preventing oscillation is applied as a control parameter by way of trial, and is calculated. The high band cut-off circular frequency is normally about 10³ [Hz] to be on the safe side.

### [Step 1: Feedback Gain Vector]

ω₃≈2π·10³ (Control parameter) [Expression 28]

(Equation 9)

k₁=ω_{c}²ω₃, k₂=ω_{c}²−ω₀²+2ζω_{c}ω₃, k₃=ω₃−2hω₀+2ζω_{c} [Expression 29]

(Equation 10)

Next, in step 2, the acceleration sensitivity S_{A} and the displacement signal sensitivity S_{D} are determined. At this time, the time constant T of the integrator and the coefficient G_{S} of the differentiator are applied as the control parameters. On the other hand, there is no problem even if S_{A} and S_{D} are applied to obtain A_{D}, T, and G_{S}.
[Step 2: Sensitivity]

$$\begin{matrix}[ Expression 30 ] & \\ {A}_{D} = {k}_{3} {S}_{V} , {S}_{D} = \frac{{S}_{V}}{T} , {S}_{A} = \frac{{G}_{S} {A}_{D}}{{k}_{3}} & ( Equation 11 )\end{matrix}$$

$$( T , {G}_{S} : Control parameters )$$

Finally, in step 3, the feedback impedances R_{V}, R_{D}, and R_{I} in FIG. 5 are determined.
[Step 3: Feedback Impedance]

$$\begin{matrix}[ Expression 31 ] & \\ {R}_{I} = ( \frac{G}{m} ) \cdot ( \frac{{k}_{3}}{{k}_{1}} ) {S}_{D} , {R}_{D} = ( \frac{G}{m} ) \cdot ( \frac{{k}_{3}}{{k}_{2}} ) {S}_{V} , {R}_{V} = ( \frac{G}{m} ) {S}_{A} & ( Equation 12 )\end{matrix}$$

Step 4 is validation operation, and the obtained transfer function of the FSF sensor is calculated. Here, H_{A}(s), H_{V}(s), and H_{D}(s) represent transfer functions related to the acceleration, velocity, and displacement outputs of the FSF sensor with respect to the acceleration, velocity, and displacement inputs, respectively. The pole structures of these transfer functions are obtained from a common characteristic equation Δ (s)=0.
[Step 4: Transfer Function]

$$\begin{matrix}[ Expression 32 ] & \\ Δ ( s ) = {s}^{2} + ( 2 h {ω}_{o} + {k}_{3} ) s + ( {ω}_{o}^{2} + {k}_{2} ) + {k}_{1} / s & ( Equation 13 )\end{matrix}$$

$${H}_{D} ( s ) = \frac{( \frac{{A}_{D}}{T} )}{s Δ ( s )} , {H}_{V} ( s ) = \frac{{A}_{D}}{Δ ( s )} , {H}_{A} ( s ) = \frac{{sA}_{D} {G}_{S}}{Δ ( s )}$$

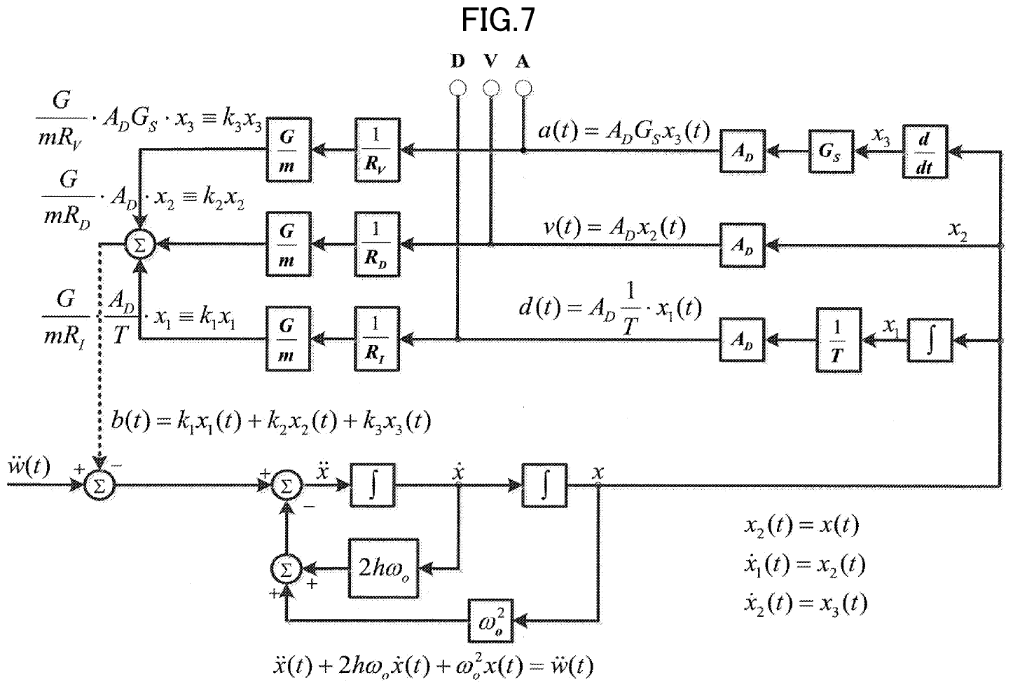

A block diagram of the FSF sensor constructed in the above-described steps is as illustrated in FIG. 7 using the state vector:

$$\begin{matrix}[ Expression 33 ] & \\ x ( t ) = {[ \int x ( t ) dt , x ( t ) , \frac{dx ( t )}{dt} ]}^{′} ≡ {[ {x}_{1} ( t ) , {x}_{2} ( t ) , {x}_{3} ( t ) ]}^{′} & ( Equation 14 )\end{matrix}$$

In FIG. 7, at the output terminals D, V, and A of the FSF sensor,

y(t)=[d(t) v(t) a(t)]′ [Expression 34]

(Equation 15)

is obtained as an output (it should be noted that an observation noise is not introduced at this point). In addition, the restoring acceleration

\ddot{ŵ}(t)≡b(t) [Expression 35]

(Equation 16)

is expressed, using

k=[k₁, k₂, k₃]′ [Expression 36]

(Equation 17)

, as

b(t)=k′·x(t) [Expression 37]

(Equation 18)

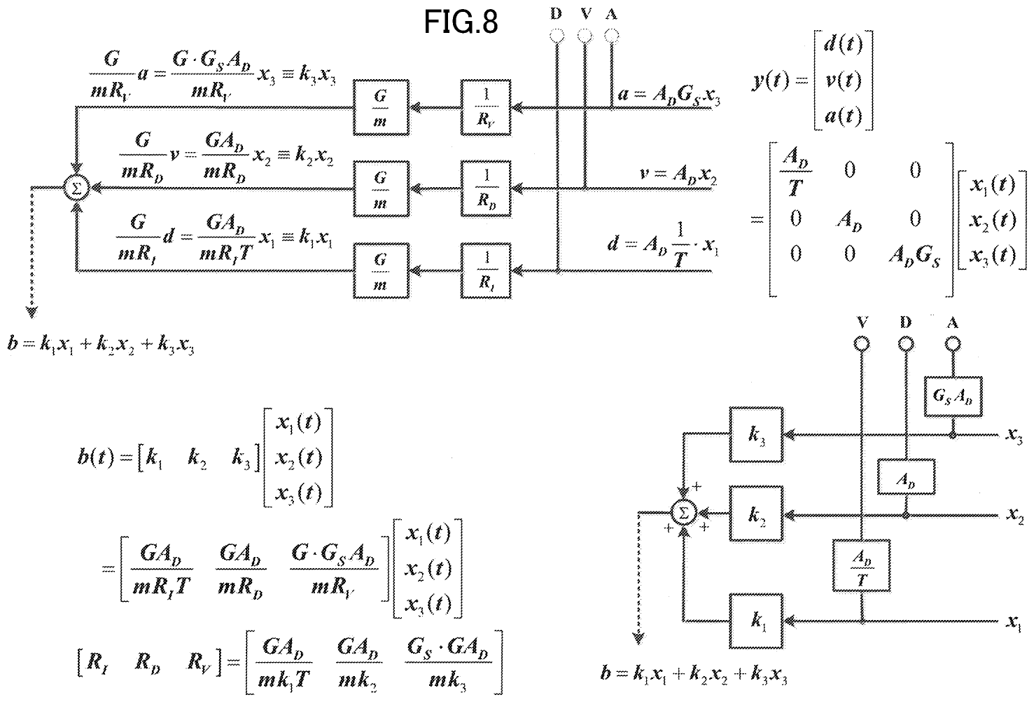

, (inner product calculation) (this is the meaning of the full state feedback). The details are as illustrated in FIG. 8. FIG. 8 is a diagram in which only portions of the restoring acceleration b(t) and the state vector x(t) are extracted, and visualizes the equation 18.

When the block diagrams of FIGS. 7 and 8 are expressed in mathematical formulas or in a state space form, the following equations are defined as follows.

\dot{x}(t)=Ax(t)+B\ddot{w}(t) [Expression 38]

where

$$A ≡ [ \begin{matrix}0 & 1 & 0 \\ 0 & 0 & 1 \\ - {k}_{1} & - ( {ω}_{o}^{2} + {k}_{2} ) & - ( 2 h {ω}_{o} + {k}_{3} )\end{matrix} ] , B ≡ [ \begin{matrix}\begin{matrix}0 \\ 0\end{matrix} \\ 1\end{matrix} ] \qquad ( Equation 19 )$$

$$and$$

$$k = [ {\begin{matrix}\begin{matrix}{k}_{1} & {k}_{2}\end{matrix} & {{k}_{3} ]}^{′} = [ \begin{matrix}\frac{{GA}_{D}}{mrT} & \begin{matrix}\frac{{GA}_{D}}{{mR}_{D}} & \frac{G \cdot {G}_{S} {A}_{D}}{{mR}_{V}} ]\end{matrix}\end{matrix}\end{matrix}}^{′}$$

$$\begin{matrix}[ Expression 39 ] & \\ y ( t ) = {C}^{′} x ( t ) , {C}^{′} = [ \begin{matrix}{A}_{D} / T & 0 & 0 \\ 0 & {A}_{D} & 0 \\ 0 & 0 & {A}_{D} {G}_{S}\end{matrix} ] & ( Equation 20 )\end{matrix}$$

If only the velocity output is observed in the observation vector, (Equation 20) is expressed by the following equation.

v(t)=C′x(t), C=[0 A_{D} 0]′ [Expression 40]

(Equation 21)

Design examples of the FSF sensor are as follows in a case where the VBB type is a target. First, a geophone element is assumed in which the mass of the pendulum is set to m=0.09 [kg], the natural frequency is set to f₀=1.5 [Hz], the attenuation coefficient is set to 0.4, and the motor generator constant is set to G=56 [N/A]. Next, the characteristics of the VBB are set to S_{V}=750 [V/(m/s)] and

$$\begin{matrix}[ Expression 41 ] & \\ {ω}_{c} = 2 π \cdot ( \frac{1}{120} ) . & ( Equation 22 )\end{matrix}$$

When f₃=1.062 [kHz] is applied under the above-described conditions, the feedback gain becomes

k₁=18.2975[s⁻³], k₂=352.96[s⁻²], k₃=6,667[s^{-1]} [Expression 42]

(Equation 23)

, and

a_{d}=5×10⁶[V/m] [Expression 43]

(Equation 24)

is obtained. Furthermore, if

T=80[s], G_{S}=0.003[s⁻¹] [Expression 44]

(Equation 25)

, the sensitivity of the acceleration output

S_{A}=2.2523[V/(m/s²)] [Expression 45]

(Equation 26)

, and the sensitivity of the displacement output

S_{D}=9.375[V/m] [Expression 46]

(Equation 27)

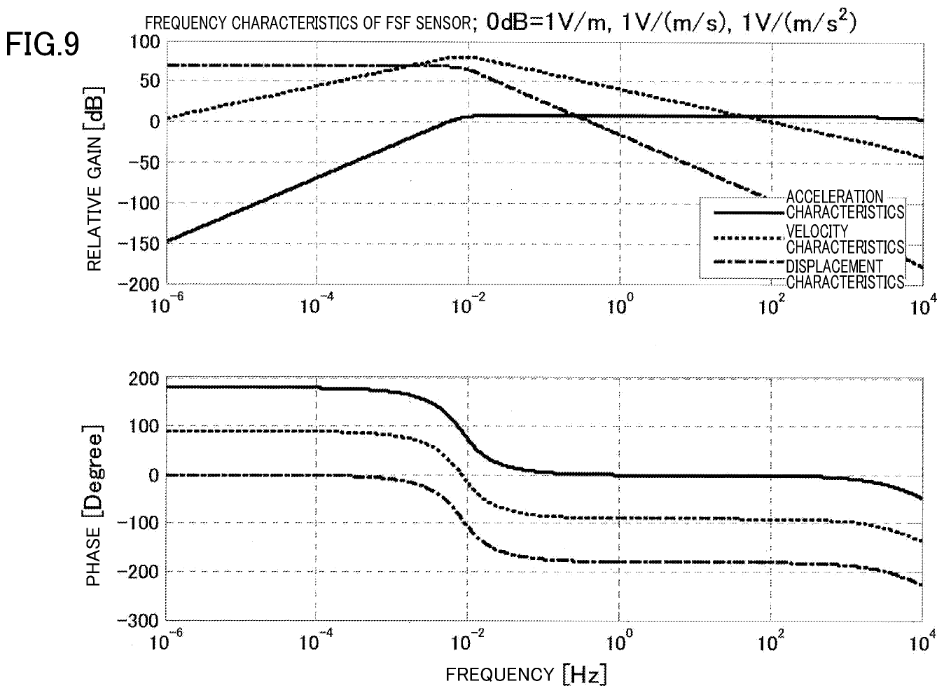

are obtained. The frequency response characteristics of the acceleration, velocity, and displacement outputs with respect to the acceleration input of the designed FSF sensor are as shown in FIG. 9. These are standard VBB characteristics. The output from the displacement (D) terminal provides characteristics of DC sensitivity with respect to the acceleration input in the same manner as the actual VBB device. In the gain characteristics expressed in dB in the figure,

1[V/(m/s²)], 1[V/(m/s)], 1[V/m] [Expression 47]

is set to 0 [dB].

The model of the high-sensitivity velocimeter described above is summarized as follows. When the state vector is expressed by

$$\begin{matrix}[ Expression 48 ] & \\ x ( t ) = {[ \int x ( t ) dt , x ( t ) , \frac{d x ( t )}{d t} ]}^{′} ≡ {[ {x}_{1} ( t ) , {x}_{2} ( t ) , {x}_{3} ( t ) ]}^{′} , & ( Equation 28 )\end{matrix}$$

$$\dot{x} ( t ) = A x ( t ) + B \ddot{w} ( t ) \qquad [ Expression 49 ]$$

where

$$A ≡ [ \begin{matrix}0 & 1 & 0 \\ 0 & 0 & 1 \\ - {k}_{1} & - ( {ω}_{o}^{2} + {k}_{2} ) & - ( 2 h {ω}_{o} + {k}_{3} )\end{matrix} ] , B ≡ [ \begin{matrix}\begin{matrix}0 \\ 0\end{matrix} \\ 1\end{matrix} ] \qquad ( Equation 29 )$$

$$and$$

$$k = [ {\begin{matrix}\begin{matrix}{k}_{1} & {k}_{2}\end{matrix} & {{k}_{3} ]}^{′} = [ \begin{matrix}\frac{{GA}_{D}}{{mR}_{I} T} & \begin{matrix}\frac{{GA}_{D}}{{mR}_{D}} & \frac{G \cdot {G}_{S} {A}_{D}}{{mR}_{V}} ]\end{matrix}\end{matrix}\end{matrix}}^{′}$$

$$v ( t ) = {C}^{′} x ( t ) , C = [ \begin{matrix}\begin{matrix}0 & {A}_{D}\end{matrix} & {0 ]}^{′}\end{matrix} \qquad [ Expression 50 ]$$

(Equation 30)

Here,

v(n) [Expression 51]

is a quantity not including the observation noise.

(Equation 28) to (Equation 30) are representation of the continuous time system, but when the sampling time ΔT is transformed, as a parameter, to a discrete system, they are expressed by

nΔT≤t<(n+1)ΔT [Expression 52]

(Equation 31)

, and under the condition of

\ddot{w}(n)=\ddot{w}(nΔT)=\ddot{w}(t) [Expression 53]

(Equation 32)

, the following equation is obtained.

x(n+1)=Φx(n)+B_{w}\ddot{w}(n) [Expression 54]

(Equation 33)

### Here,

Φ≡e^{AΔT} [Expression 55]

(Equation 34)

and

B_{w}≡∫₀^{ΔT} e^{A(ΔT-τ)}B dτ [Expression 56]

(Equation 35)

v(n)=C′x(n) [Expression 57]

(Equation 36)

With respect to the linear model of (Equation 33) to (Equation 36) (in this stage, both of the system noise and the observation noise are not introduced. For the block diagram of the system, see FIG. 6.), the system noise already described using (Equation 2)

q(n) [Expression 58]

(the normality noise with average 0 and covariance matrix Q(n)) is introduced. Furthermore, the quantity obtained by adding the observation noise r(n) to

v(n) [Expression 59]

is newly defined as y₂(n) as follows.

y₂(n)=v(n)+r(n) [Expression 60]

(Equation 37)

The observation noise r(n) is the normality noise with average 0 and variance R(n). The above-described (Equation 37) is a signal model of the high-sensitivity velocimeter in the case where there is the observation noise.

As described above, the configuration of the sensor fusion of FIG. 2 is described by the following linear system

x(n+1)=ψx(n)+B_{w}\ddot{w}(n)+q(n), Q=E[q(n)Q′(n)] y₂(n)=C′x(n)+r(n) [Expression 61]

(Equation 38)

including the system noise and the observation noise.

In this model, when (Equation 38) is described as

y₂(n)=v(n)+r(n) [Expression 62]

(Equation 39)

,

r(n)=y₂(n)−v(n) [Expression 63]

(Equation 40)

is obtained, and therefore if, in the range in which the VBB is not clipped,

\ddot{w}(n) [Expression 64]

can be obtained with sufficient accuracy,

y₂(n)≡v(n) [Expression 65]

(Equation 41)

is obtained, resulting in

r(n)≈0 [Expression 66]

(Equation 42)

In the range in which the VBB is clipped, if

|y₂(n)|>>|v(n)| [Expression 67]

(Equation 43)

r(n)≅y₂(n) [Expression 68]

(Equation 44)

is obtained, but this means not

v(n)≈0 [Expression 69]

(Equation 45)

, but

|v(n)|<<|r(n)|[Expression 70]

(Equation 46)

The signal observed by the VBB is modeled by the observation noise r(n) of this nature. In (Equation 38), as further extension of interpretation, r(n) is modeled as the time-varying normality noise with average 0 and variance R(n).

State Estimation by Kalman Filter

The linear Kalman filter when there is a control input is applicable to the system of (Equation 38). The prediction step and the filtering step of the linear Kalman filter in this case are as follows.

$$\begin{matrix}[ Expression 71 ] & \\ Prediction step : \overline{x} ( n ) = Φ \hat{x} ( n - 1 ) + {B}_{w} \ddot{w} ( n - 1 ) & ( Equation 47 )\end{matrix}$$

$$\overline{P} ( n ) = Φ \hat{P} ( n - 1 ) {Φ}^{′} + Q ( n )$$

$$Q ( n ) \leq [ \begin{matrix}{T}^{2} & 0 & 0 \\ 0 & 1 & 0 \\ 0 & 0 & \frac{1}{{G}_{S}^{2}}\end{matrix} ] / {A}_{D}^{2} ≡ {Q}_{o}$$

$$Filtering step : K ( n ) = \frac{\overline{P} ( n ) C}{{C}^{′} \overline{P} ( n ) C + R ( n - {n}_{o} )}$$

$$\hat{x} ( n ) = \overline{x} ( n ) + K ( n ) [ {γ}_{2} ( n ) - {C}^{′} \overline{x} ( n ) ]$$

$$\hat{P} ( n ) = [ I - K ( n ) {C}^{′} ] \overline{P} ( n ) .$$

In (Equation 47),

x̅(n) [Expression 72]

is a prior state estimate of the state vector

x(n) [Expression 73]

, and

P̅(n) [Expression 74]

is a prior covariance matrix (a prior error covariance matrix) which is a prior value of a covariance matrix (an error covariance matrix)

P(n) [Expression 76]

related to the state vector

x(n) [Expression 75]

\hat{x}(N−1) [Expression 77]

is an estimate of the state vector

x(n−1) [Expression 78]

at the discrete time n⁻1, and

\hat{P}(n−1) [Expression 79]

is a post covariance matrix which is a value of the covariance matrix

P(n−1) [Expression 80]

at the discrete time n−1 which is calculated by the Kalman filter.

\hat{x}(n) [Expression 81]

is an estimate of the state vector

x(n) [Expression 82]

at the discrete time n, and

\hat{P}(n) [Expression 83]

is a post covariance matrix which is a value of the covariance matrix

P(n) [Expression 84]

at the discrete time n which is calculated by the Kalman filter. Furthermore,

I [Expression 85]

is an identity matrix (a matrix of three rows by three columns in the present embodiment).

As described above, the system noise and the observation noise are introduced, which makes it possible to perform the sensor fusion (to estimate the state of the FSF sensor or the pendulum of the high-sensitivity geophone) using the Kalman filter.

Operation Flow of Vibration Sensor System

Next, a general operational flow of the vibration sensor system 1 will be described separately for during design and during operation.

During Design

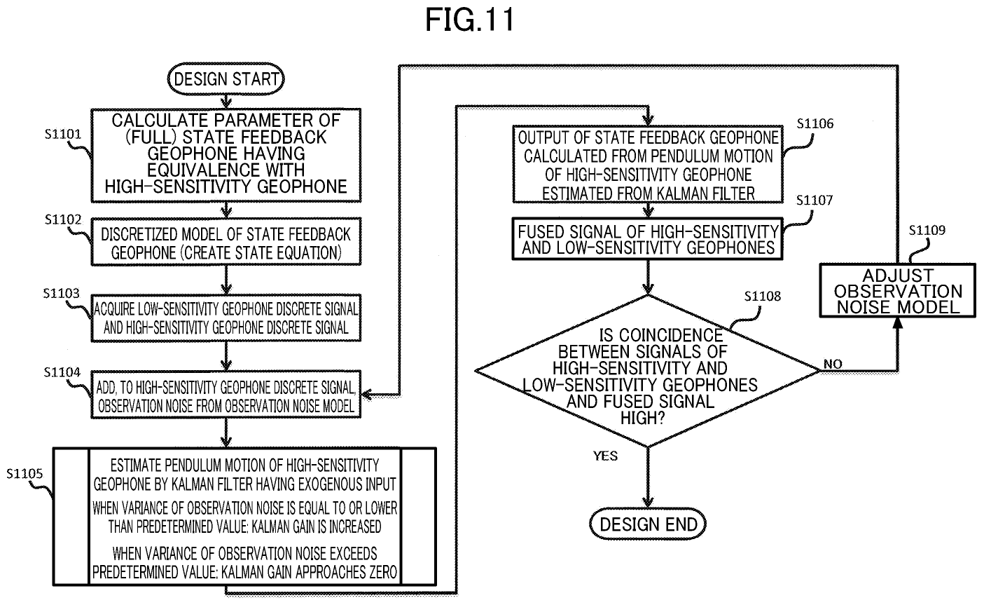

FIG. 11 is a flowchart illustrating an operational flow during design of the vibration sensor system. In step S1101, the processing unit 209 of the estimation device 2 executes a simulated sensor generation program stored in the storage unit 210, and thereby calculates parameters of the (full) state feedback geophone having characteristics equivalent to those of the high-sensitivity geophone which are described using the above-described (Equation 6) to (Equation 36). Thus, the discretized model of the state feedback geophone described in (Equation 33) to (Equation 36) is generated (step S1102). The data of various parameters and the like which are used in this model is used in the processing using the Kalman filter by the estimation device 2, and therefore the data of various parameters and the like is stored in the storage unit 210 of the estimation device 2 (see FIG. 4).

Subsequently, the input-output unit 211 of the estimation device 2 acquires a low-sensitivity geophone discrete signal (an acceleration record) from the external measurement device 3 and acquires a high-sensitivity geophone discrete signal (a velocity record) from the vibration sensor 4 from moment to moment (step S1103), and the data of these acquired records is stored in the storage unit 210. The simulated sensor (the processing unit 209) adds, to the high-sensitivity geophone discrete signal, an observation signal from the observation noise model as described in (Equation 37) (step S1104), and generates a linear system including the system noise (Equation 38). Hereinafter, the simulated sensor acquires the acceleration records from the external measurement device 3 from moment to moment, generates the system noise and the observation noise from the respective noise models (are predefined and stored in the storage unit 210. As described later, the noise models are adjustable afterward.) from moment to moment, and continues to generate the high-sensitivity velocity record y₂(n) according to the model of (Equation 38) at each discrete time n. Note that in the state vector in (Equation 38)

x(n) [Expression 86]

, the initial value at n=0 is previously provided and stored, as the state estimation program data, in the storage unit 210 (the same applies to variables requiring initial values for the others such as the system noise).

Next, the processing unit 209 of the estimation device 2 executes a state estimation program using the acquired record data, and the various types of data stored in the storage unit 210, thereby estimates pendulum motion of the high-sensitivity geophone by the Kalman filter having an exogenous input according to (Equation 47), and the calculation of the estimate

\hat{x}(n) [Expression 88]

of the state vector

x(n) [Expression 87]

and the calculation of the value by the Kalman filter

\hat{P}(n) [Expression 90]

of the post covariance matrix of the estimation error

P(n) [Expression 89]

are performed from moment to moment (step S1105). Note that

R(n−n₀) [Expression 91]

in the Kalman gain in (Equation 47) is the variance of the observation noise, or an externally settable quantity (a “Kalman gain adjustment term”) (in an example, the quantity is input by a user via the input-output unit 211 and is stored, as the state estimation program data, in the storage unit 210 by the processing unit 209 that executes the state estimation program). When a velocity indicated in the velocity record input from the vibration sensor 4 is greater than a predetermined value (in an example, the value is input by a user via the input-output unit 211 and is stored, as the state estimation program data, in the storage unit 210 by the processing unit 209 that executes the state estimation program) (e.g., when the velocity record of the high-sensitivity velocimeter is saturated), the processing unit 209 that executes the state estimation program increases the Kalman gain adjustment term as compared with the case where the velocity is smaller than the predetermined value, whereby the Kalman gain can be reduced.

The output of the state feedback geophone that is calculated from the pendulum motion of the high-sensitivity geophone estimated by the above-described Kalman filter is obtained by the estimation by the Kalman filter by the processing unit 209 that executes the state estimation program (S1106). The output is a fused signal of the high sensitivity (vibration sensor 4) and the low sensitivity (external measurement device 3) (S1107), and each component of the estimated state vector is displayed by the display device of the input-output unit 211, whereby a user can know the estimated state of the pendulum.

Furthermore, during the design, the processing unit 209 that executes the state estimation program makes comparison determination between the record values of acceleration, velocity and the like indicated by the signals from the external measurement device 3 and the vibration sensor 4 and the values of acceleration, velocity and the like calculated from the state vector estimated using the Kalman filter (step S1108). In an example, when a difference between the record values indicated by the signals from the external measurement device 3 and the vibration sensor 4 and the values calculated from the state vector estimated using the Kalman filter exceeds a predetermined value at a certain discrete time, the processing unit 209 that executes the state estimation program determines that the coincidence between the record values and the calculated values is low (“NO” in the conditional branch of step S1108), and adjusts the observation noise model by changing the magnitude of the variance of the observation noise (step S1109). Using the observation noise from the observation noise model after the adjustment, the processes from step S1104 to step S1108 are performed again. These processes are repeated until it is determined in step S1108 that the coincidence is high. When it is determined in step S1108 that the coincidence is high (in an example, when a difference between the record values indicated by the signals from the external measurement device 3 and the vibration sensor 4 and the values calculated from the state vector estimated using the Kalman filter does not exceed the predetermined value. “YES” in the conditional branch of step S1108), the design ends.

During Operation

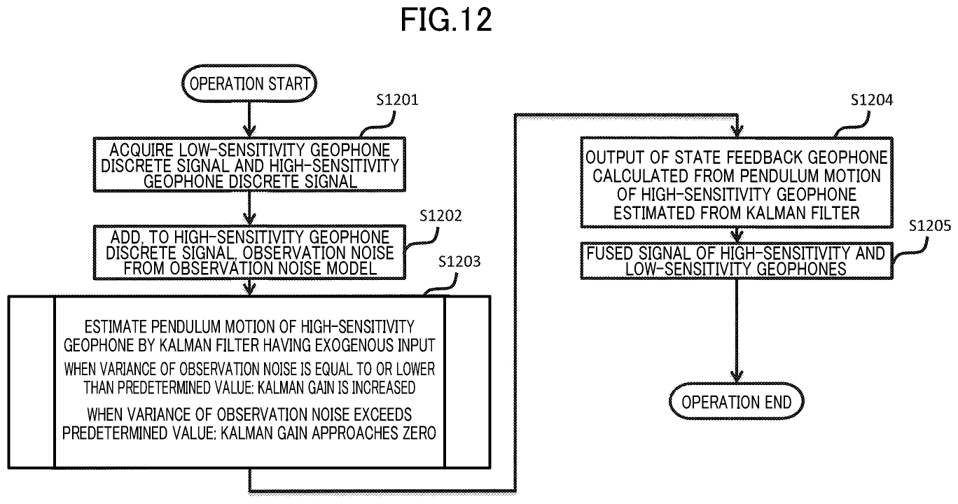

The linear system of (Equation 38) and the Kalman filter of (Equation 47) are determined including various calculation parameters and noise models, by the design process illustrated using FIG. 11. During the operation, using these, the state vector related to the vibration sensor 4 is estimated at discrete times from moment to moment (the estimation is repeated while incrementing the value of n=1, 2, . . . ). The flowchart during the operation is as illustrated in FIG. 12. Steps S1201, S1202, S1203, S1204, and S1205 may be the same as steps S1103, S1104, S1105, S1106, and S1107 during the design, respectively.

Details of Calculation by Kalman Filter

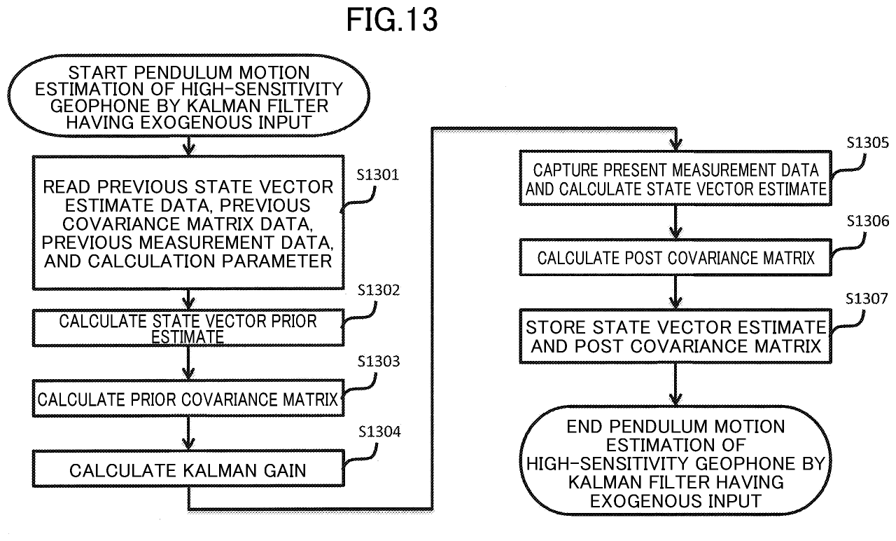

The detailed flow of the calculation by the Kalman filter which is performed in step S1105 in the flowchart of FIG. 11 and step S1203 in the flowchart of FIG. 12 is illustrated in the flowchart of FIG. 13.

First, the state vector prior estimate calculation unit 204 reads, from the storage unit 210, the previous state vector estimate data, the previous post covariance matrix data, the previous measurement data, and the calculation parameters (step S1301). The read data is temporarily stored in the RAM of the processing unit 209 (the temporary storage of various types of data in the RAM is omitted as necessary in the following description and the above description. Reading of various types of data from the storage unit is also omitted as necessary). To perform the initial estimation or perform the process using (Equation 47) in which n=1, the previous state vector estimate data, the previous post covariance matrix data, and the previous measurement data (each data obtained at n=0) each are initial value data that is previously stored in the storage unit 210 via the input-output unit 211 by the user and is provided from the outside.

Subsequently, the state vector prior estimate calculation unit 204 calculates the prior estimate of the state vector

x̅(n) [Expression 93]

according to the equation of the prediction step

x̅(n)=Φ\hat{x}(n−1)+B_{w} \ddot{w}(n−1) [Expression 92]

(Equation 48)

Equation 47) (step S1302), and is temporarily stored in the RAM of the processing unit 209.

Next, the prior covariance matrix calculation unit 205 calculates the prior covariance matrix

P̅(n) [Expression 95]

according to the equation of the prediction step

P̅(n)=Φ\hat{P}(n−1)Φ′+Q(n) [Expression 94]

(Equation 49)

in (Equation 47) (step S1303), and is temporarily stored in the RAM of the processing unit 209.

Next, the Kalman gain calculation unit 206 calculates the Kalman gain according to the equation of the filtering step

$$\begin{matrix}[ Expression 96 ] & \\ K ( n ) = \frac{\overline{P} ( n ) C}{{C}^{′} \overline{P} ( n ) C + R ( n - {n}_{o} )} & ( Equation 50 )\end{matrix}$$

in (Equation 47) (step S1304), and is temporarily stored in the RAM of the processing unit 209. Here, the Kalman gain calculation unit 206 adjusts the Kalman gain by the calculation using the Kalman gain adjustment term

R(n−n₀) [Expression 97]

. Specifically, when a value (v(n)) of the high-sensitivity geophone discrete signal acquired in step S1103 in the flow of FIG. 11 or step S1201 in the flow of FIG. 12 is larger than a predetermined value, the Kalman gain adjustment term is increased as compared with the case where the value is smaller than the predetermined value, so that the Kalman gain is reduced, whereby the Kalman gain is adjusted. Also when a sensor value from the vibration sensor 4 is not the velocity record but a displacement record or an acceleration record, the Kalman gain calculation unit 206 similarly adjusts the Kalman gain via the Kalman gain adjustment term according to the comparison result between the corresponding predetermined value and the sensor value (when values of one or more of the displacement, the velocity, and the acceleration of the pendulum as the sensor values from the vibration sensor 4 are larger than the respective predetermined values, the Kalman gain adjustment term is increased as compared with the case where one or more values are smaller than the respective predetermined value).

Next, the state vector estimate calculation unit 207 calculates the state vector estimate

\hat{x}(n) [Expression 99]

according to the equation of the filtering step

\hat{x}(n)=x̅(n)+K(n) [y₂ (n)−C′x̅(n)] [Expression 98]

(Equation 51)

in (Equation 47) (step S1305), and is temporarily stored in the RAM of the processing unit 209.

Next, the post covariance matrix calculation unit 208 calculates the post covariance matrix

\hat{P}(n) [Expression 101]

according to the equation of the filtering step

\hat{P}(n)=[I−K(n)C′]\hat{P}(n) [Expression 100]

(Equation 52)

in (Equation 47) (step S1306), and is temporarily stored in the RAM of the processing unit 209.

Next, in step S1307, the state vector estimate calculation unit 207 stores, in the storage unit 210, the state vector estimate estimated in step S1305 (the state vector estimate at the discrete time n is used as the “previous state vector estimate data” in a Kalman filter process at the discrete time n+1), and the post covariance matrix calculation unit 208 stores, in the storage unit 210, the post covariance matrix calculated in step S1306 (the post covariance matrix at the discrete time n is used as the “previous post covariance matrix data” in a Kalman filter process at the discrete time n+1). In addition, the processing unit 209 that executes the state estimation program stores, in the storage unit 210, the various types of data of the measurement acquired from the external measurement device 3 (the measurement at the discrete time n is used as the “previous measurement data” in a Kalman filter process at the discrete time n+1). The processes in steps S1301 to S1307 are repeated from moment to moment together with the data signal acquisition processes in step S1103 and step 1201 (the flow may be a flow in which all the data acquisition processes are performed first, and then all the Kalman filter processes are performed, or in which the Kalman filter process is performed at a certain discrete time immediately after the data is acquired at the discrete time, the discrete time is incremented by one (incrementation), the data is acquired at the next discrete time, and then the Kalman filter process is performed, so that the data acquisition and the Kalman filter process may be synchronized with each other), and the process by the Kalman filter ends when a predetermined end condition is satisfied that the low-sensitivity geophone discrete signal and the high-sensitivity geophone discrete signal are not acquired or the discrete time reaches a predetermined end value.

The process according to the flow during the operation illustrated in FIG. 12 including the Kalman filter process in the flow illustrated in FIG. 13 is repeated from moment to moment, whereby the state vector (the state vector of the pendulum) related to the vibration sensor 4 that changes from moment to moment is estimated. The state vector estimate is displayed on the display device of the input-output unit 211 by the processing unit 209 that executes the state estimation program, which makes it possible for the user to confirm the state vector estimate.

### Second Embodiment

Model of High-Sensitivity Displacement Sensor

Next, an embodiment where a high-sensitivity displacement sensor is used as the vibration sensor 4 will be described as a second embodiment of the present invention. However, as for portions that are identical to those in the first embodiment, description thereof will be omitted.

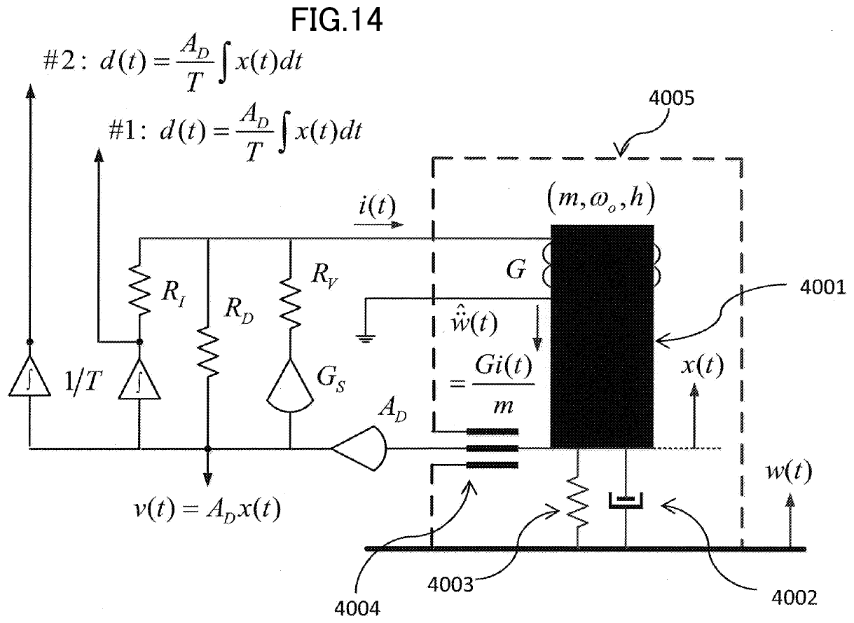

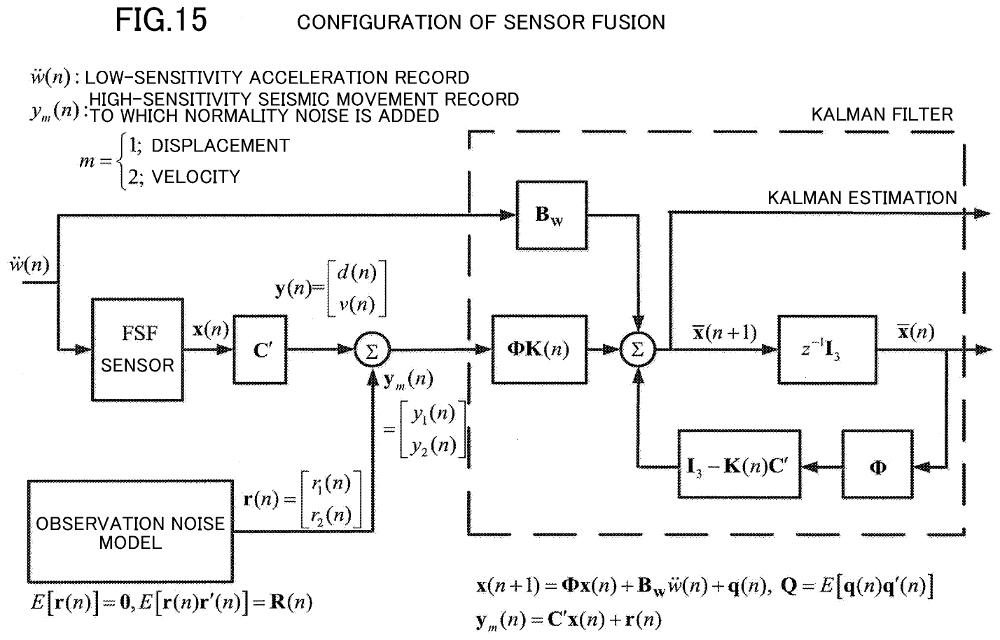

FIG. 14 is a diagram illustrating an example of the vibration sensor (a VBB seismometer as the high-sensitivity displacement sensor). FIG. 15 is a block diagram illustrating a configuration of sensor fusion of the high-sensitivity displacement sensor and the strong motion seismometer using the Kalman filter. The high-sensitivity displacement sensor is achieved by the same configuration as that of the velocimeter of FIG. 5.

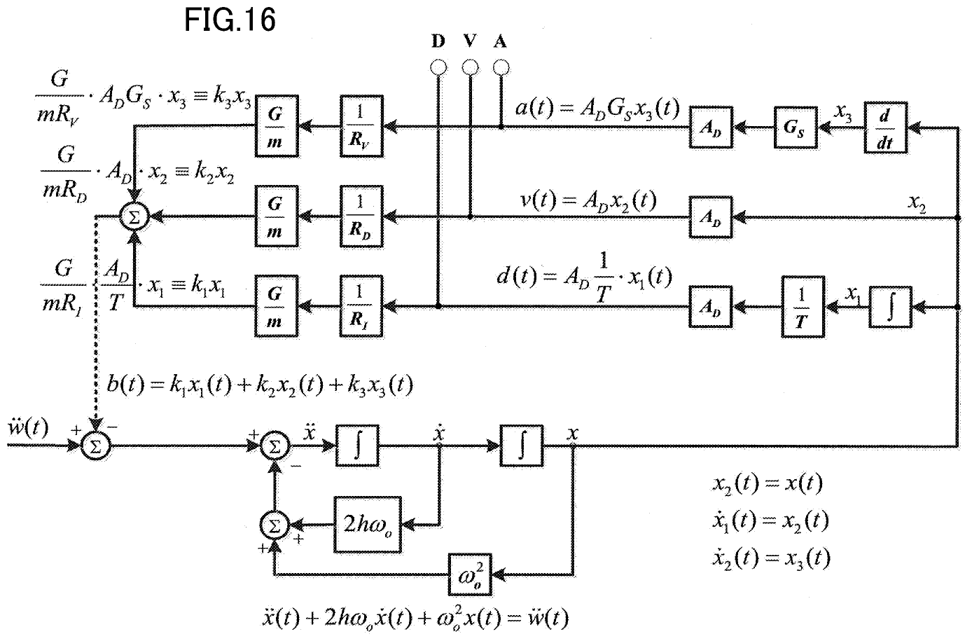

In the vibration sensor of FIG. 14, a displacement signal can be extracted from a position of #1 of FIG. 14, but is generally obtained through the external integrator having attenuation characteristics outside the measurement band as indicated by a position of #2. The continuous-time system state space representation in the measurement band is as illustrated in FIG. 16, but the displacement signal

d(t) [Expression 102]

and the velocity signal

v(t) [Expression 103]

are output simultaneously, and therefore these signals can be used together.

At this time, when the state vector of the pendulum related to the vibration sensor 4 is expressed by

$$\begin{matrix}[ Expression 104 ] & \\ x ( t ) = {[ \int x ( t ) dt , x ( t ) , \frac{d x ( t )}{d t} ]}^{′} ≡ {[ {x}_{1} ( t ) , {x}_{2} ( t ) , {x}_{3} ( t ) ]}^{′} , & ( Equation 53 )\end{matrix}$$

the state space representation is expressed by

\dot{x}(t)=Ax(t)+B\ddot{w}(t) [Expression 105]

where

$$A ≡ [ \begin{matrix}0 & 1 & 0 \\ 0 & 0 & 1 \\ - {k}_{1} & - ( {ω}_{o}^{2} + {k}_{2} ) & - ( 2 h {ω}_{o} + {k}_{3} )\end{matrix} ] , B ≡ [ \begin{matrix}\begin{matrix}0 \\ 0\end{matrix} \\ 1\end{matrix} ] \qquad ( Equation 54 )$$

$$and$$

$$k = [ {\begin{matrix}\begin{matrix}{k}_{1} & {k}_{2}\end{matrix} & {{k}_{3} ]}^{′} = [ \begin{matrix}\frac{{GA}_{D}}{{mR}_{I} T} & \begin{matrix}\frac{{GA}_{D}}{{mR}_{D}} & \frac{G \cdot {G}_{S} {A}_{D}}{{mR}_{V}} ]\end{matrix}\end{matrix}\end{matrix}}^{′} .$$

$$, and$$

$$\begin{matrix}[ Expression 106 ] & \\ y ( t ) = [ \begin{matrix}d ( t ) \\ v ( t )\end{matrix} ] = {C}^{′} x ( t ) , C = [ \begin{matrix}{A}_{D} / T & 0 \\ 0 & {A}_{D} \\ 0 & 0\end{matrix} ] & ( Equation 55 )\end{matrix}$$

When the sampling time ΔT is transformed, as a parameter, to a discrete system, the representation of the continuous time system is expressed by

nΔT≤t<(n+1)ΔT [Expression 107]

(Equation 56)

, and under the condition of

\ddot{w}(n)=\ddot{w}(nΔT)=\ddot{w}(t) [Expression 108 ]

(Equation 57)

, the following equation is obtained:

x(n+1)=Φx(n)+B_{w}\ddot{w}(n), [Expression 109]

where

$$Φ ≡ {e}^{A Δ T} and {B}_{W} ≡ {\int }_{0}^{Δ T} {e}^{A ( Δ T - τ )} Bd τ \qquad ( Equation 58 )$$

$$\begin{matrix}[ Expression 110 ] & \\ y ( n ) = [ \begin{matrix}d ( n ) \\ v ( n )\end{matrix} ] = {C}^{′} x ( n ) & ( Equation 59 )\end{matrix}$$

Accordingly, in view of the normality noise

$$\begin{matrix}[ Expression 112 ] & \\ r ( n ) = [ \begin{matrix}{r}_{1} ( n ) \\ {r}_{2} ( n )\end{matrix} ] & ( Equation 60 )\end{matrix}$$

with the average vector which is a zero vector (a two-dimensional column vector) and the covariance matrix

R(n) [Expression 11]

, the signal model of the high-sensitivity displacement sensor is expressed by

$$\begin{matrix}[ Expression 113 ] & \\ {y}_{m} ( n ) = [ \begin{matrix}{y}_{1} ( n ) \\ {y}_{2} ( n )\end{matrix} ] = y ( n ) + r ( n ) , & ( Equation 61 )\end{matrix}$$

and the sensor fusion can be performed by the following Kalman filter.

$$\begin{matrix}[ Expression 114 ] & \\ Prediction step : \overline{x} ( n ) = Φ \hat{x} ( n - 1 ) + {B}_{w} \ddot{w} ( n - 1 ) & ( Equation 62 )\end{matrix}$$

$$\overline{P} ( n ) = Φ \hat{P} ( n - 1 ) {Φ}^{′} + Q ( n )$$

$$Q ( n ) \leq [ \begin{matrix}{T}^{2} & 0 & 0 \\ 0 & 1 & 0 \\ 0 & 0 & \frac{1}{{G}_{S}^{2}}\end{matrix} ] / {A}_{D}^{2} ≡ {Q}_{o}$$

$$Filtering step : K ( n ) = \frac{\overline{P} ( n ) C}{{C}^{′} \overline{P} ( n ) C + R ( n - {n}_{o} )}$$

$$\hat{x} ( n ) = \overline{x} ( n ) + K ( n ) [ {y}_{m} ( n ) - {C}^{′} \overline{x} ( n ) ]$$

$$\hat{P} ( n ) = [ I - K ( n ) {C}^{′} ] \overline{P} ( n )$$

The device configuration and the operational flows during the design and during the operation of the vibration sensor system 1 can be achieved in the same manner as in the first embodiment except that after the system noise

q(n) [Expression 115]

is introduced in the same manner as in the first embodiment,

x(n+1)=Φx(n)+B_{w}\ddot{w}(n)+q(n), Q=E[q(n)q′(n)] yₘ(n)=C′x(n)+r(n) [Expression 116]

(Equation 63)

is used as the equation of the linear system and the equation of (Equation 62) is used as the equation of the Kalman filter.

### Third Embodiment

Model of High-Sensitivity Accelerometer

Next, an embodiment where a high-sensitivity accelerometer is used as the vibration sensor 4 will be described as a third embodiment of the present invention. However, as for portions that are identical to those in the first embodiment, description thereof will be omitted.

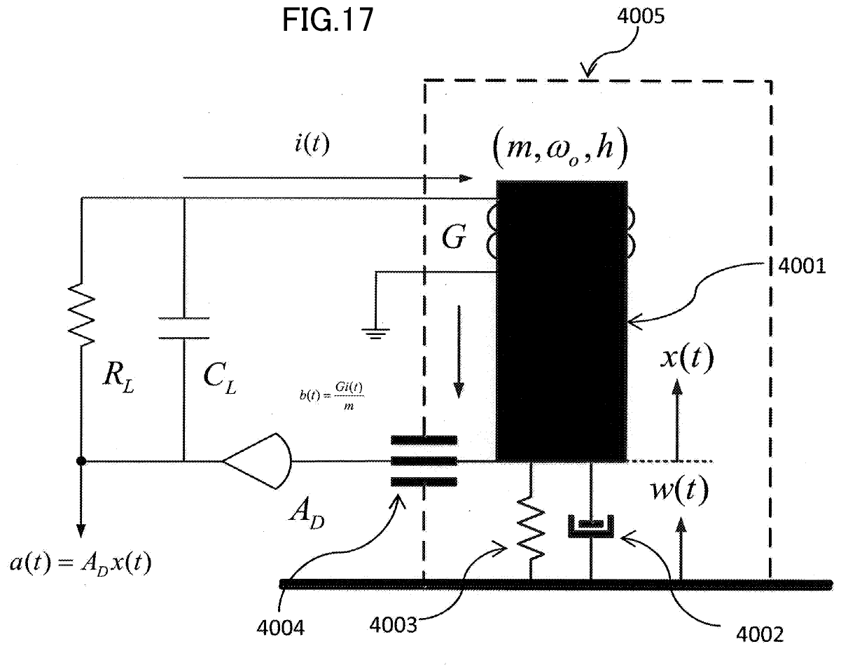

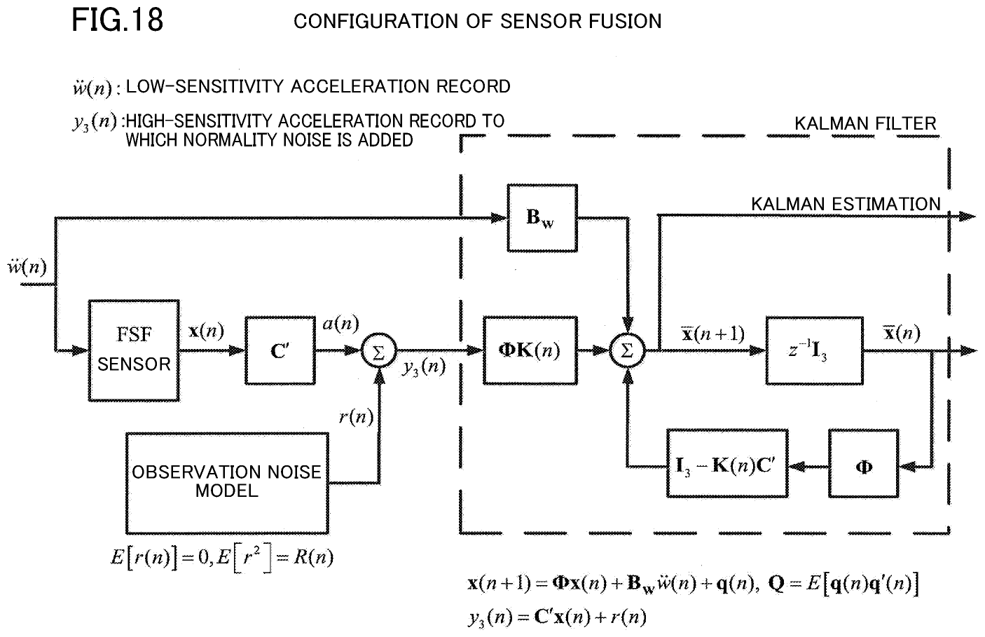

FIG. 17 is a diagram illustrating an example of a vibration sensor (ₐ hi_{g}h-sensitivity accelerometer). FIG. 18 is a block diagram illustrating a configuration of sensor fusion of the high-sensitivity accelerometer and the strong motion seismometer using a Kalman filter. The high-sensitivity accelerometer can be achieved by the same configuration as that of the velocimeter of FIG. 5.

In the case of the VBB accelerometer of FIG. 5, the acceleration signal is output from a terminal A of FIG. 7 as

a(t) [Expression 117]

### When

v(t) [Expression 118]

of the high-sensitivity velocimeter is replaced with

a(t) [Expression 119]

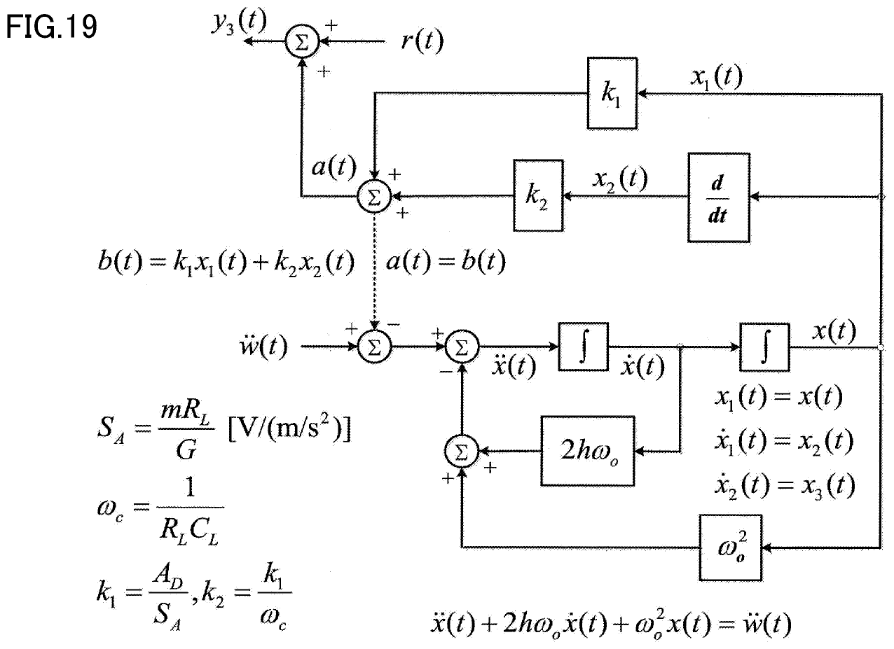

, the sensor fusion can be performed. However, in the seismometer having the configuration of FIG. 5, the sensitivity becomes zero at the frequency 0, and the seismometer is disadvantageous as compared with the force balance negative feedback accelerometer used usually. Here, the normal negative feedback accelerometer illustrated in FIG. 17 is used as the high-sensitivity accelerometer. The continuous-time system state space representation with respect to the accelerometer of FIG. 17 is illustrated in FIG. 19.

When the state vector of the pendulum related to the vibration sensor 4 is expressed by

$$\begin{matrix}[ Expression 120 ] & \\ x ( t ) = {[ x ( t ) , \frac{dx ( t )}{d t} ]}^{′} ≡ {[ {x}_{1} ( t ) , {x}_{2} ( t ) ]}^{′} , & ( Equation 64 )\end{matrix}$$

the state space representation of FIG. 19 is expressed by

\dot{x}(t)=Ax(t)+B\ddot{w}(t) [Expression 121]

where

$$A ≡ [ \begin{matrix}0 & 1 \\ - ( {ω}_{o}^{2} + {k}_{1} ) & - ( 2 h {ω}_{o} + {k}_{2} )\end{matrix} ] , B ≡ [ \begin{matrix}0 \\ 1\end{matrix} ] \qquad ( Equation 65 )$$

$$k = [ \begin{matrix}{k}_{1} & {{k}_{2} ]}^{′} = [ \begin{matrix}\frac{{GA}_{D}}{{mR}_{L}} & {\frac{{GA}_{D}}{{mR}_{L} {ω}_{c}} ]}^{′} , {ω}_{c} = \frac{1}{{C}_{L} {R}_{L}}\end{matrix}\end{matrix} ,$$

$$\begin{matrix}[ Expression 122 ] & \\ a ( t ) = {C}^{′} x ( t ) , C = [ \begin{matrix}{k}_{1} & {{k}_{2} ]}^{′}\end{matrix} . & ( Equation 66 )\end{matrix}$$

When the sampling time ΔT is transformed, as a parameter, to a discrete system, the representation of the continuous time system is expressed by

nΔT≤t>(n+1)ΔT [Expression 123]

(Equation 67)

, and under the condition of

\ddot{w}(n)=\ddot{w}(nΔT)=\ddot{w}(t) [Expression 124]

(Equation 68)

, the following equation is obtained:

x(n+1)=Φx(n)+B_{w} \ddot{w}(n), [Expression 125]

where

Φ≡e^{AΔT} and B_{w}≡∫₀^{ΔT} e^{A(ΔT-τ)}B dτ (Equation 69)

,

a(n)=C′x(n) [Expression 126]

(Equation 70)

.

Accordingly, in view of the normality noise

r(n) [Expression 128]

with average 0 and variance

R(n) [Expression 127]

, the signal model of the high-sensitivity accelerometer is expressed by

y₃(n)=a(n)+r(n) [Expression 129]

(Equation 71)

, and the sensor fusion can be performed by the Kalman filter illustrated in FIG. 18

$$\begin{matrix}[ Expression 130 ] & \\ Prediction step : \overline{x} ( n ) = Φ \hat{x} ( n - 1 ) + {B}_{w} \ddot{w} ( n - 1 ) & ( Equation 72 )\end{matrix}$$

$$\overline{P} ( n ) = Φ \hat{P} ( n - 1 ) {Φ}^{′} + Q ( n )$$

$$Q ( n ) \leq [ \begin{matrix}1 & 0 \\ 0 & 1\end{matrix} ] / {A}_{D}^{2} ≡ {Q}_{o}$$

$$Filtering step : K ( n ) = \frac{\overline{P} ( n ) C}{{C}^{′} \overline{P} ( n ) C + R ( n - {n}_{o} )}$$

$$\hat{x} ( n ) = \overline{x} ( n ) + K ( n ) [ {y}_{3} ( n ) - {C}^{′} \overline{x} ( n ) ]$$

$$\hat{P} ( n ) = [ I - K ( n ) {C}^{′} ] \overline{P} ( n ) .$$

The device configuration and the operational flows during the design and during the operation of the vibration sensor system 1 can be achieved in the same manner as in the first embodiment except that after the system noise

q(n) [Expression 131]

is introduced in the same manner as in the first embodiment,

x(n +1)=Φx(n)+B_{w} \ddot{w}(n)+q(n), Q=E[q(n)q′(n)] y₃(n)=C′x(n)+(n) [Expression 132]

(Equation 73)

is used as the equation of the linear system and the equation of (Equation 72) is used as the equation of the Kalman filter.

### INDUSTRIAL APPLICABILITY

The present invention can be utilized in the state estimation related to all the vibration sensors including the seismometer.

### REFERENCE SIGNS LIST

1 Vibration sensor system
2 Estimation device
3 External measurement device (low-sensitivity geophone)
4 Vibration sensor (high-sensitivity geophone)
200 Kalman filter calculation unit
201 Measurement acquisition unit
202 Data storage unit
203 Sensor value acquisition unit
204 State vector prior estimate calculation unit
205 Prior covariance matrix calculation unit
206 Kalman gain calculation unit
207 State vector estimate calculation unit
208 Post covariance matrix calculation unit
209 Processing unit
210 Storage unit
211 Input-output unit
4001 Pendulum connected to servo coil
4002 Damping element
4003 Rigid element
4004 Displacement detector (three capacitive plates)
4005 Container

1. An estimator that estimates, according to discrete time, a state vector related to a vibration sensor and calculates a covariance matrix related to the state vector according to the discrete time, the state vector changing in time according to an external input, the estimator comprising:
a measurement acquirer that acquires a measurement measured by an external measurer of a physical quantity related to vibration as the external input;
a sensor value acquirer that acquires a sensor value of the vibration sensor;
a data storage that stores a state vector estimate obtained by previous estimation, a post covariance matrix obtained by previous calculation, the measurement corresponding to a time corresponding to the previous estimation and the previous calculation, and a covariance matrix of a system noise; and
a calculator configured to work as:
a state vector prior estimate calculator that calculates a state vector prior estimate using the state vector estimate obtained by the previous estimation and the measurement corresponding to the time corresponding to the previous estimation and the previous calculation;
a prior covariance matrix calculator that calculates a prior covariance matrix using the post covariance matrix obtained by the previous calculation and the covariance matrix of the system noise;
a Kalman gain calculator that calculates a Kalman gain using the prior covariance matrix;
a state vector estimate calculator that calculates a state vector estimate in present estimation using the state vector prior estimate, the Kalman gain, and the sensor value; and
a post covariance matrix calculator that calculates a post covariance matrix in present calculation using the prior covariance matrix and the Kalman gain.

2. A vibration sensor assembly, comprising:
a vibration sensor;
an external measurer; and
an estimator that estimates, according to discrete time, a state vector related to the vibration sensor and calculates a covariance matrix related to the state vector according to the discrete time, the state vector changing in time according to an external input, the estimator comprising:
a measurement acquirer that acquires a measurement measured by the external measurer of a physical quantity related to vibration as the external input
a sensor value acquirer that acquires a sensor value of the vibration sensor;
a data storage that stores a state vector estimate obtained by previous estimation, a post covariance matrix obtained by previous calculation, the measurement corresponding to a time corresponding to the previous estimation and the previous calculation, and a covariance matrix of a system noise; and
a calculator configured to work as:
a state vector prior estimate calculator that calculates a state vector prior estimate using the state vector estimate obtained by the previous estimation and the measurement corresponding to the time corresponding to the previous estimation and the previous calculation;
a prior covariance matrix calculator that calculates a prior covariance matrix using the post covariance matrix obtained by the previous calculation and the covariance matrix of the system noise;
a Kalman gain calculator that calculates a Kalman gain using the prior covariance matrix;
a state vector estimate calculator that calculates a state vector estimate in present estimation using the state vector prior estimate, the Kalman gain, and the sensor value; and
a post covariance matrix calculator that calculates a post covariance matrix in present calculation using the prior covariance matrix and the Kalman gain.

3. The vibration sensor assembly according to claim 2, wherein the external measurer is capable of converting acceleration by calculation, and has a dynamic range exceeding an upper limit of a dynamic range of the vibration sensor, and the measurement acquirer acquires a measurement of the acceleration.

4. The vibration sensor assembly according to claim 2, wherein the vibration sensor comprises a pendulum, and measures values of one or more of displacement, velocity, and acceleration, and the sensor value acquirer acquires the values of one or more of the displacement, the velocity, and the acceleration.

5. The vibration sensor assembly according to claim 4, wherein the Kalman gain calculator adjusts a Kalman gain by calculation using a Kalman gain adjustment term, and when the values of one or more of the displacement, the velocity, and the acceleration of the vibration sensor are greater than predetermined values, the Kalman gain is adjusted to increase the Kalman gain adjustment term as compared with a case where the one or more values are smaller than the predetermined values, so that the Kalman gain is reduced.

6. The vibration sensor assembly according to claim 2, wherein
the vibration sensor
is a vibration sensor that comprises a pendulum and measures values of one or more of displacement, velocity, and acceleration, and
is provided, by a subsequent-stage Kalman filter, with a simulated sensor that simulates an operation of a vibration sensor comprising a pendulum by calculation, and determines values of one or more of displacement, velocity, and acceleration of a simulated pendulum by calculation, and
the state vector estimate calculator uses, as the sensor value, the values of one or more of the displacement, the velocity, and the acceleration measured by the vibration sensor or values obtained by multiplying a coefficient by the values of one or more of the displacement, the velocity, and the acceleration of the simulated pendulum determined by the simulated sensor, according to magnitudes of the values of one or more of the displacement, the velocity, and the acceleration measured by the vibration sensor.

7. A method, to be executed by an estimator, of estimating, according to discrete time, a state vector related to a vibration sensor and calculating a covariance matrix related to the state vector according to the discrete time, the state vector changing in time according to an external input, the method comprising:
acquiring a measurement measured by an external measurer of a physical quantity related to vibration as the external input;
acquiring a sensor value of the vibration sensor;
calculating a state vector prior estimate using a state vector estimate obtained by previous estimation and a measurement corresponding to a time corresponding to the previous estimation and previous calculation;
calculating a prior covariance matrix using a post covariance matrix obtained by the previous calculation and a covariance matrix of a system noise;
calculating a Kalman gain using the prior covariance matrix;
calculating a state vector estimate in present estimation using the state vector prior estimate, the Kalman gain, and the sensor value; and
calculating a post covariance matrix in present calculation using the prior covariance matrix and the Kalman gain.

8. (canceled)

9. The vibration sensor assembly according to claim 3, wherein the vibration sensor comprises a pendulum, and measures values of one or more of displacement, velocity, and acceleration, and the sensor value acquirer acquires the values of one or more of the displacement, the velocity, and the acceleration.

10. The vibration sensor assembly according to claim 3, wherein
the vibration sensor
is a vibration sensor that comprises a pendulum and measures values of one or more of displacement, velocity, and acceleration, and
is provided, by a subsequent-stage Kalman filter, with a simulated sensor that simulates an operation of a vibration sensor comprising a pendulum by calculation, and determines values of one or more of displacement, velocity, and acceleration of a simulated pendulum by calculation, and
the state vector estimate calculator uses, as the sensor value, the values of one or more of the displacement, the velocity, and the acceleration measured by the vibration sensor or values obtained by multiplying a coefficient by the values of one or more of the displacement, the velocity, and the acceleration of the simulated pendulum determined by the simulated sensor, according to magnitudes of the values of one or more of the displacement, the velocity, and the acceleration measured by the vibration sensor.
